(19) United States
(12) Patent Application Publication
(10) Pub. No.: US 2026/0363204 A1
(43) Pub. Date: Nov. 19, 2026

(54) ADAPTIVE AUTOMATED PET FOOD DISPENSER

(71) Applicant: MYTHOS PET FOODS INC., Palo Alto, CA (US)

(72) Inventors: Grant Edward BARNEKOW, Palo Alto, CA (US); Benjamin Adams DAKE, Stanford, CA (US)

(21) Appl. No.: 19/673,338

(22) Filed: May 11, 2026

Related U.S. Application Data
(60) Provisional application No. 63/808,516, filed on May 19, 2025.

(51) Int. Cl. A01K 5/02

(52) U.S. Cl. CPC A01K 5/0216; A01K 5/0283

(57) ABSTRACT

A wet pet food dispenser is configured to adaptively deliver wet pet food to a pet with an accuracy within about 1 gram from a wet pet food container to decrease food waste and improve pet health. The wet pet food dispenser is configured to deliver at least about 95% of the food in the container, so the container can be recycled. The container comprises recyclable components such as food safe plastic and metal, and a hydrophobic outlet, to decrease residue on the outlet when the wet pet food, which comprises water, which decreases waste, improves sanitation, and improves accuracy. A user interface is configured to adaptively adjust pet feeding in response to the pet’s needs. The pet food dispenser comprises a code reader to read the wet pet food container, and a camera and a processor configured to recognize a face of the pet.

### RELATED APPLICATIONS

This application claims the priority benefit of U.S. Provisional Application Serial No. 63/808,516, filed May 19, 2025, entitled "ADAPTIVE AUTOMATED PET FOOD DISPENSER," the disclosure of which is incorporated by reference herein in its entirety.

### BACKGROUND

The prior approaches to feeding pets can be less than ideal in at least some instances. The prior approaches to feeding pets may result in less than ideal quality of the environment and more energy consumption than would be ideal in at least some instances, in other words less green than would be ideal. Currently, the feeding of pets such as cats can lead to significant amounts of food waste, for example due to spoilage. Also, the prior containers of pet food may be less than ideally suited for recycling in at least some instances. Furthermore, the amount of food fed to a pet can be less than ideal, which can result in obesity or food waste, for example. Pet owners may face challenges dispensing the correct amount of food to a pet such as a cat. This can result in food waste and residual food that is not consumed being left in a bowl.

Older cats may suffer from malnutrition, and the prior approaches can be less than ideal for addressing this in at least some instances. Work in relation to the present disclosure suggests that pet health can be related to nutrition, and that many pets have nutritional needs that may be less than ideally addressed with the prior approaches. Also, the prior approaches may be less than ideally suited to tracking the source of the pet food delivered to the pet, which can result in the food not having the intended ingredients and nutrition, and may result in impurities, such as contaminants, in the pet food, for example.

Prior approaches to feeding pets may result in a larger carbon food print associated with carbon dioxide (CO2) and other green house emissions in a least some instances. For example, the waste of pet food associated with the prior approaches may ultimately result in increased energy consumption and CO2 emissions in relation to the energy used to make food. Also, some pet owners will have someone feed their pet while they are away, and this person may drive to feed the pet with an energy powered vehicle, and the round trips associated with travelling to and from the pet may increase greenhouse gas emissions in at least some instances.

Although efforts have been made to automate pet feeding, the prior approaches can be less than ideal. In some instances a pet owner may have more than one pet, and a pet may eat the wrong food in the absence of human supervision. Also the prior approaches can result in too much food or too little food being given to a pet, for example when the feeding regimen is not appropriately adapted to the pet. Also, work in relation to the present disclosure suggests that at least some of the prior approaches to automated pet feeding may be less accurate than would be ideal, which can also contribute to food waste and may make it difficult to determine the correct amount of food to provide to a pet. Also, the prior approaches may less than ideally track pet food consumption and may provide less than ideal results when comparing pet food consumption to pet health.

Work in relation to the present disclosure also suggests that the current approaches to providing wet pet food to a pet can result in significant amounts of food waste in at least some instances. For example, when a can is opened, the can may not be adequately sealed so that the wet pet food becomes dry and needs to be disposed of, in at least some instances.

The prior approaches to automated pet feeding can be less than ideally suited for recycling. In some instances, prior approaches with containers can leave more residual food in a container than would be ideal. For example, at least some prior approaches to dispensing food may result in a container that is not well suited for recycling because too much food is left in the container.

Work in relation to present disclosure suggests that prior approaches to limiting pet access to automated feeders can be less than ideal in at least some instance. For example, a least some of the prior approaches may not scale well, for example when new animals and feeders are added to a pet owners home and allowed to interact. Also, at least some of the prior approaches may be less reliable than would be ideal, at may utilize fewer images than images than would be ideal and can be subject to false positives or false negatives, which result in the wrong pet being allowed access to the feeder or the correct pet not being fed, for example when fur color and lighting vary. Work in relation to the present disclosure also suggests that there may be less than ideal utilization of resources, and at least some embedded processing systems may not be well suited to running AI algorithms such a neural networks continuously.

Wet pet food can come in many different types, such as pâté, chunky and mousse. Work in relation to the present disclosure suggests that prior approaches to automated pet feeding can provide less than ideal performance with these different types of pet foods, in at least some instances.

In light of the above, it would be desirable to have improved pet feeding that ameliorates at least some of the aforementioned limitations of the prior approaches.

### SUMMARY

Embodiments of the present disclosure provide improved pet food containers and dispensers, which may result in less waste, more accurate pet feeding, improved recycling of used containers, and more adaptive automated pet feeding. In some embodiments, these features improve the quality of the environment and decrease energy consumption.

In some embodiments, an environmentally friendly pet food dispenser is configured to adaptively deliver wet pet food to a pet feeding receptacle with an accuracy within about 1 gram from a wet pet food container, thereby decreasing food waste and improving pet health. In some embodiments, the wet pet food dispenser is configured to receive a wet pet food container and deliver at least about 95% of the food in the container, so the container can be recycled, and the container comprises recyclable components such as food safe plastic and metal. In some embodiments, the wet pet food container comprises a hydrophobic outlet, to decrease residual wet pet food on the outlet when the wet pet food, which comprises water is dispensed.

In some embodiments, the wet pet food dispenser comprises a plunger coupled to a linear actuator with an encoder. In some embodiments, the plunger is configured to engage a backstay of a food container supported with a receptacle at a dispensing location. In some embodiments, the actuator and plunger are configured to deliver a sufficient amount of force to the backstay to dispense wet pet food through an outlet comprising a diameter of no more than about 10 mm, for example no more than 8 mm. In some embodiments, the backstay, a wall of the container and a base of the container each comprise rigidity so that the amount of pet food dispensed corresponds to linear displacement of the plunger coupled to the actuator and encoder. In some embodiments, a processor is operatively coupled to the plunger to dispense wet pet food with the plunger in response to signals from the encoder. In some embodiments, one or more of the container or the plunger comprises an engagement structure to align a proximal end of the container with the plunger. In some embodiments, the rigid backstay, the rigid base and side wall of the container, in combination with an appropriately sized hydrophobic outlet provides accurate wet pet food dispensing.

In some embodiments, a user interface is configured for a user to adaptively adjust pet feeding in response to the pet’s needs, thereby reducing food waste and improving pet health. In some embodiments, the pet food dispenser comprises a code reader to read the wet pet food container, which helps to ensure safety of the pet food and reduce risk of pet food contaminants. In some embodiments, the pet food dispenser comprises a camera and a processor configured to recognize a face of the pet, to help ensure that the correct pet receives the meal.

### INCORPORATION BY REFERENCE

All patents, applications, and publications referred to and identified herein are hereby incorporated by reference in their entirety, and shall be considered fully incorporated by reference even though referred to elsewhere in the application.

### BRIEF DESCRIPTION OF THE DRAWINGS

A better understanding of the features, advantages and principles of the present disclosure will be obtained by reference to the following detailed description that sets forth illustrative embodiments, and the accompanying drawings of which:

FIGS. 1A and 1B are schematic diagrams depicting an automated pet feeding system comprising an automated pet food dispenser and operation of the automated pet food dispenser, in accordance with some embodiments.

FIG. 2A is a front view of an automated pet food dispenser, in accordance with some embodiments.

FIG. 2B is a partial cutaway perspective view of the automated pet food dispenser of FIG. 2A, in accordance with some embodiments.

FIG. 2C and 2D are a perspective views of the automated pet food dispenser of FIG. 2A with the upper housing opened, in accordance with some embodiments.

FIG. 2E is a perspective view of the automated pet food dispenser of FIG. 2A with the upper housing opened and transparent to reveal the internal structure, in accordance with some embodiments.

FIG. 2F is a detailed view of the automated pet food dispenser of FIG. 2A with the upper housing opened and transparent to reveal the internal structure, in accordance with some embodiments.

FIGS. 3A and 3B are exploded cutaway views of a food container, in accordance with some embodiments.

FIG. 3C is an assembled cutaway view of the food container of FIGS. 3A and 3B, in accordance with embodiments.

FIG. 4A is a bottom view of a backstay for a food container, in accordance with embodiments.

FIGS. 4B1 and 4B2 are top and side views of the backstay of FIG. 4A, in accordance with embodiments.

FIG. 4C is a cutaway side view of the backstay of FIG. 4A, in accordance with embodiments.

FIG. 5A is a top view of a dispensing end comprising a insert or cap for a food container, in accordance with embodiments.

FIG. 5B is a bottom view of the dispensing end comprising the insert or cap of FIG. 5A, in accordance with embodiments.

FIG. 5C is a perspective cutaway view of the dispensing end comprising insert or cap of FIG. 5A, in accordance with embodiments.

FIG. 6 is a process flow diagram of a method for automated food dispensing, in accordance with embodiments.

FIG. 7 shows a method of feeding a pet with a pet feeding system, in accordance with some embodiments.

FIG. 8 is a schematic diagram depicting an automated pet food dispenser, in accordance with some embodiments.

FIGS. 9A and 9B are schematic diagrams depicting internal structures of an automated pet food dispenser, in accordance with some embodiments.

FIG. 10 is a schematic diagram depicting an internal structure of an automated pet food dispenser, in accordance with some embodiments.

FIG. 11 is a schematic diagram depicting a cross-sectional view of a portion of an automated pet food dispenser, in accordance with some embodiments.

FIG. 12 is a schematic diagram depicting a cross-sectional view of a bowl tray assembly, in accordance with some embodiments.

FIG. 13 is a schematic diagram depicting a view of an automated pet food dispenser, in accordance with some embodiments.

FIG. 14 is a schematic diagram depicting a portion of an automated pet food dispenser, in accordance with some embodiments.

FIG. 15 is a schematic diagram depicting an internal structure of an automated pet food dispenser, in accordance with some embodiments.

### DETAILED DESCRIPTION

The following detailed description provides a better understanding of the features and advantages of the inventions described in the present disclosure in accordance with the embodiments disclosed herein. Although the detailed description includes many specific embodiments, these are provided by way of example only and should not be construed as limiting the scope of the inventions disclosed herein.

The presently disclosed methods and apparatuses provide improved approaches to the automated feeding of animals such as pets. Although reference is made to feeding pets, the presently disclosed methods and apparatuses are well suited for the automated feeding of other animals such as livestock, wild animals, animals undergoing veterinary care, and humans receiving care, such as in an assisted living in a facility.

While the pet may be any type of animal, in some embodiments the pet comprises a furry animal with fur on its face and fur over 80% of its body, such as a dog or cat.

The wet pet food referred to herein comprises a flowable pet food material that flows when subjected to force, for example extruded through an outlet of a container. In some embodiments, the wet pet food comprises an amount of water within a range from about 60% percent to about 90%. In some embodiments, the wet pet food comprises a material that does not flow through an opening smaller than 10 mm unless the wet pet food is subjected to a force greater than gravity. In other words, in some embodiments, the wet pet food is not a liquid, although the wet pet food may comprise a liquid such as water.

The presently disclosed systems and methods provide improved pet food dispensing, with a plurality of containers and automated dispenser. In some embodiments, the system is configured to provide adaptive meal planning for a specific pet. In some embodiments, the system is configured to determine pet food consumption with each feeding of a plurality of feedings and to adjust or recommend adjustments to the amount of food dispensed for each feeding. For example, if pet does not eat all of the food, the system can reduce the amount of food for the next meal, either automatically or in response to user input. In some embodiments, there is a learning phase for each pet, and the system is configured to profile the consumption behavior of a specific pet associated with a specific dispenser. The amount of food fed to each pet and the frequency can be adjusted by the user, for example with system prompts or notifications, or automatically. These choices in the feeding frequency and amounts can be made for the user automatically, or the user is allow to change these with input to user interface of a computing device. In some embodiments, the system is configured to make algorithmic adjustments, such as to one or more of the frequency, timing, or amount of food dispensed for each meal. For example, a pet may have gastrointestinal issues, and the system can be configured to provide more frequent meals with a smaller volume. Alternatively or in combination, the system can be configured to weigh the food after each feeding and adjust the amount of food in response to the amount of food after each feeding. In some embodiments, the system is configured to receive demographic data of a pet, such as species, breed, height and weight and provide meals appropriate to the specific pet, which the user can modify with an app running on a mobile computing device such as a smart phone, for example.

In some embodiments, the pet food dispenser is configured to receive a plurality of wet pet food containers, which can be stored and used when needed to feed the pet. In some embodiments, a carousel is used to sequentially rotate the plurality of wet pet food containers into position for dispensing.

In some embodiments, the presently disclosed methods and apparatuses provide decreased food degradation after food from a container has been partially dispensed. In some embodiments, the container comprises one or more substantially air tight seals to maintain freshness of the foods. In some embodiments, a movable structure, such as a backstay comprises a gasket to seal against an interior of the container to decrease food waste and provide more complete delivery of food and improve the recyclability of a dispensed wet pet food container. Alternatively or in combination, an outlet on a distal end of the wet pet food dispenser may comprise a seal or other similar structure, such as a small orifice, to maintain freshness of the food.

In some embodiments, the wet pet food container comprises a dispensing outlet, such as a nozzle or other orifice sized to deliver the wet pet food in response to a suitable amount of force from a plunger to the wet pet food container. In some embodiments, the outlet comprises an approximate maximum dimension across within a range from about 1/8 of an inch to about 1/4 inch, e.g. about 3/16 of an inch. Work in relation to the present disclosure suggests that an opening within this range is well suited to delivery different types of wet pet food such as one or more of broths, shreds or pate. Alternatively or in combination, the outlet may comprise an elastically deformable opening, such as a cross or X shaped opening with dimensions within this range. In some embodiments, the maximum dimension across comprises a diameter, for example when the orifice of the outlet comprise a circular aperture.

In some embodiments, the outlet comprises an insert that can be inserted into the wet pet food container prior to placing the wet pet food in the container.

In some embodiments, the wet pet food container comprises backstay with a gasket, and the food dispensing outlet with the wet pet food located therebetween in the container.

In some embodiments, the wet pet food dispenser is configured so that only the bowl and the wet pet food container touch the food, which has the advantages of improving sanitation, decreasing waste and improving recyclability of the wet pet food container. In some embodiments, the wet pet food container comprises a cannister such as a three piece can, and a backstay configured to receive the plunger, and a food delivery outlet that is placed above the bowl and allows the food to drop from the outlet onto the bowl with relatively little food remaining on the dispensing outlet, for example. In some embodiments, the outlet comprises a hydrophobic material, such as silicone or plastic, to decrease accumulation of dispensed pet food on the outlet. In some embodiments, the outlet is removed with the container from the wet pet food dispenser, so that the outlet has limited use and is used with only the wet pet food container.

In some embodiments, the wet pet food container is shipped to a customer with all of the parts assembled together. In some embodiments, the wet pet food container comprises a reusable container configured for the customer to place food in the container by removing the backstay. Alternatively or in combination, the wet pet food container can be shipped to the customer with the wet pet food contained therein.

In some embodiments, the wet pet food container is shipped to the customer as a sealed container. For example, the container may comprise a seal on the distal end, such as a foil seal, that ruptures when the wet pet food is dispensed through the outlet. Alternatively or in combination, the proximal end may comprise a seal, which can be removed by the customer or ruptured in response to force from the plunger. The seals have the advantage of increasing the shelf life of the sealed wet pet food container, which may comprise meat, for example.

In some embodiments, the wet pet food container is configured to be recycled after use. In some embodiments, the wet pet food container is configured to deliver at least about 95% of the wet pet food initially within the container in a sealed configuration, which improves the recyclability of the container after the wet pet food has been dispensed. In other words, no more than about 5% of the wet pet food remains in the container when it is removed from the dispenser. In some embodiments, at least about 96% of the wet pet food initially within the container in the sealed configuration is delivered, and in some instances at least about 97% of the food the wet pet food within the container in the sealed configuration is delivered. In some embodiments, the wet pet food container comprises approximately 8-12 ounces of wet pet food, for example about 10 ounces.

In some embodiments, an overall diameter of the wet pet food container is within a range from about 2 to 3 inches. In some embodiments, the diameter corresponds to a diameter of commercially available cans such as a211 can size, which has an overall diameter of approximately 2 11/16 inches, although other diameters can be used.

In some embodiments, the wet pet food container comprises materials that are suited for recycling, such as one or more of metal or plastic. In some embodiments, the wet pet food container comprises metal side walls and a plastic backstay for example. In some embodiments, the outlet comprises an insert comprising a material composed of a hydrophobic recyclable material such as a plastic, for example. In some embodiments, the valve comprises a one-way valve. The one way valve may make it difficult to reuse the container. Alternatively or in combination, the outlet may comprise a silicone valve. In some embodiments, the insert comprises a first support component comprising metal are plastic and a second component comprising a silicone valve. In some embodiments, the valve comprises a cross-slit shape. While the outlet can be configured in many ways, in some embodiments the outlet comprises a silicone with Shore A hardness within a range from about 10 to about 70, for example within a range from about 20 to about 60, e.g. about 30. In some embodiments, the outlet comprises one or more of an opening or slits with a maximum dimension across of no more than about 10 mm and optionally no more than 8 mm.

In some embodiments, the wet pet food dispenser is configured to deliver food with an accuracy of within 5 grams, for example within about 3 grams, or 1 gram. This high resolution approach to pet feeding improves the accuracy of the food delivered and decreases waste. This accuracy is well suited for feeding cats and decreasing food waste. In some embodiments, the load cell is coupled to the processing system to measure the amount of food dispensed into the bowl. Alternatively or in combination, the plunger that engages the backstay may be coupled to encoders that determine the amount of displacement of the plunger to provide a desired amount of food. In some embodiments, the encoder is coupled to the processing system, and the processing systems is configured to measure movement of the plunger and compare an estimated amount of delivered food with the amount of delivered food measured with the load cell. This approach can be well suited to detect feeding faults, which can be helpful if the pet owner is away, for example.

In some embodiments, the displacement of the plunger corresponds to an amount of dispensed wet pet food. For example, for a 211 container of wet pet food, a displacement of 0.1 mm of the plunger corresponds to an amount of wet pet food within a range from about 0.3 grams to about 0.6 grams, for example approximately 0.38 grams of wet pet food. In some embodiments, the plunger is coupled to encoders with an appropriate resolution to dispense wet pet food with an accuracy as described herein, for example within a range from about half a gram to 5 grams.

In some embodiments, the backstay is configured to engage the plunger with a central depression that matches the diameter and size of the plunger. In some embodiments, the back stay comprises a beveled edge to guide the plunger and central axis of the pet food dispenser into alignment. In some embodiments, the back stay comprises a recess, in which the recess comprises a conically shaped beveled edge and the central depression. In some embodiments, the central depression comprises a diameter that substantially matches a diameter of the plunger, for example to within about 5%.

In some embodiments, the wet pet food container comprises a code, such one or more of a QR code, a bar code or an RFID code, and the pet food dispenser comprise a code reader. While the code can be located in any location on the wet pet food container, in some embodiments the code is located on an end of the container, such as on a proximal end of the container. In some embodiments, the code is located on the backstay for example at a central depression of the back stay, or on a covering located above the back stay, for example. In some embodiments, the code on each container comprises a unique identification code that is associated with each container.

In some embodiments, there is metadata associated with the unique identifier on each pod, which can be helpful for several reasons. In some embodiments, the meta data comprises one or more of a stock keeping unit (SKU), a wet pet food formula identification number, or authentication signature, for example. In some embodiments, the authentication signature is used to verify that the container is a legitimate container provided by a verified vendor, which can help improve nutritional safety. In some embodiments, the authentication signature comprises an encrypted authentication signature to inhibit inappropriate containers, such as non-verified containers, from being used by the dispenser. In some embodiments, the meta data is associated with manufacturing, such as a batch number or lot number. The batch number can be helpful to prevent containers from being sold or recalled, for example if there is an avian flu outbreak and the food within the wet pet food container should be recalled.

In some embodiments, the authentication code is unique to each container, and once food from the wet pet food container has been dispensed, the container cannot be reused, for example with a software check. This approach can improve pet safety by decreasing the likelihood that a container is reused. In some embodiments, the pet food dispenser is configured to communicate with a database on a remoter service, such as in the cloud, which keeps track of all container codes that have been used.

In some embodiments, the pet food dispenser comprises a code, such as a unique identification code, which can be stored in a processor of the pet food dispenser. The unique identification codes can be associated with the unique identification codes of each of the plurality of pet food containers. This association can determine which pet food containers can be used with a specific pet food container, which can decrease the likelihood of a pet being given the wrong food or medication, for example.

In some embodiments, one or more processors of the pet food dispenser is configured with anti-spoofing protections.

In some embodiments the remote processing system is configured with a database to store information associated with the unique identifier of each container and the unique identifier of each pet for dispenser. In some embodiments the database comprises an inventory system to keep track of an inventory of pet food containers on site for a specific pet food dispenser. In some embodiments, the inventory system is configured to plan reorders and prompt a user to order additional wet pet food containers. The database can be configured to determine individual pet consumption rates, provide feedback to the user such as notifications to indicate when new pet food containers should be ordered.

Although reference is made to a database, in some embodiments the remote processing system may comprises one or more of a blockchain ledger or a distributed ledger, for example.

In some embodiments, each dispenser has a unique identifier associated with a specific user or account.

In some embodiments, the system is configured to a user to make a profile for individual cats, and each cat may be assigned a unique identifier that is associated with a unique user identifier and a unique pet food dispenser identifier. This can allow the system to dispense appropriate food for a specific pet. In some embodiments, the system is configured to associate diet and specific meals to a specific pet. In some embodiments, the system is configured to provide pet food consumption data and nutrition data for a specific pet.

In some embodiments, the system can be configured to provide information such as nutrition and medicine consumption information to a veterinarian. For example, a pet may have a chronic medical condition. One or more containers placed in the dispenser may comprise a medication for the pet that is associated with a unique identifier for the one or more containers. This information can be provided to the veterinarian. In some embodiments, the amount of food consumed with a feeding is used to determine an amount of medication ingested by the pet.

In some embodiments, the system is configured with one or more artificial intelligence (AI) algorithms. In some embodiments, the system is configured to identify a specific pet, for example computer vision. In some embodiments, the system is configured to upload a plurality of images of a pet such as a cat or dog, and facial recognition performed on the pet. While many algorithms can be used, in some embodiments the AI algorithm comprises computer vision, such as a convolutional neural network to identify a particular pet. In some embodiments, an app running on a mobile computing device is configured for a user to upload images of a pet to train the AI algorithm. Once the AI algorithm has been trained, the system is capable of identifying a specific pet. In some embodiments, a plurality of images of a pet are uploaded from a user app to train the AI algorithm, for example 9 images.

The system configured with the pet facial recognition algorithm can be configured in many ways. In some embodiments, the pet facial recognition of the system provides access control of the pet food dispenser. This approach allows tracking pet consumption on individual basis. In some embodiments, if an identified pet such as a cat leaves proximity of device, the pet food dispenser automatically closes the tray, which can be helpful in the incorrect pet or other animal from eating the food. In some embodiments the pet facial recognition is used to identify the pet associated with the dispenser and open the feeding tray only if the associated pet is recognized as being in proximity of the pet food dispenser. This can be helpful in decreasing odds of the incorrect cat from eating another cats food or medication, for example.

In some embodiments, a camera on the dispenser is operatively coupled to the AI algorithm running facial recognition, and the dispenser is configured to identify when the pet is in proximity to the device, and open the tray accordingly and close the tray when the pet leaves, for example.

In some embodiments, the pet food dispenser is configured to make a sound, such as a user programmable sound to indicate that it is feeding time and the pet should approach the feeder, for example. The system can be configured to use this to trigger the camera and AI image acquisition to determine when the specified cat has approached the dispenser.

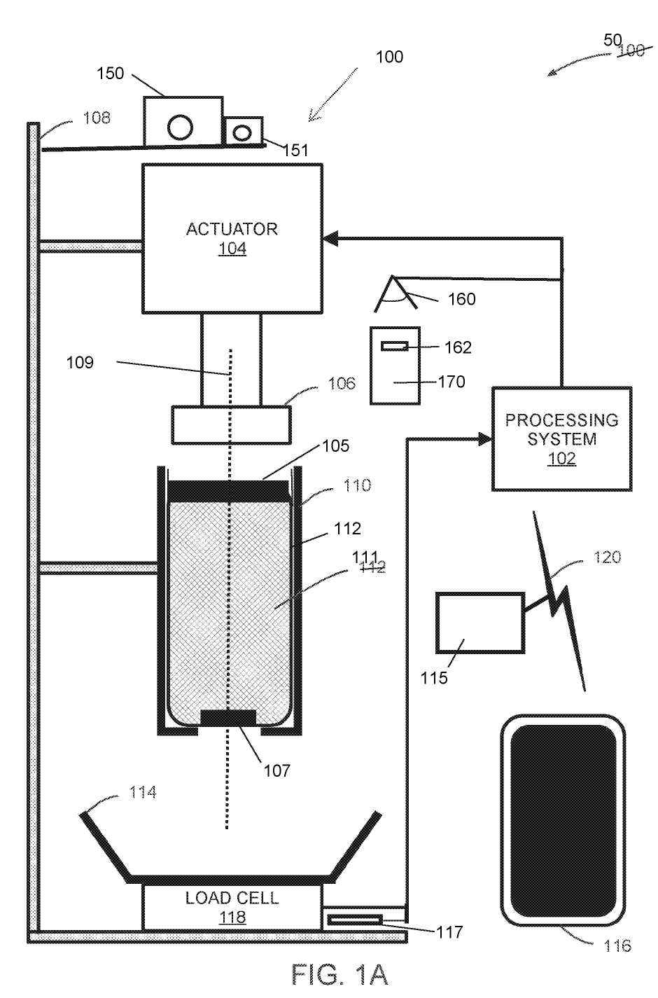

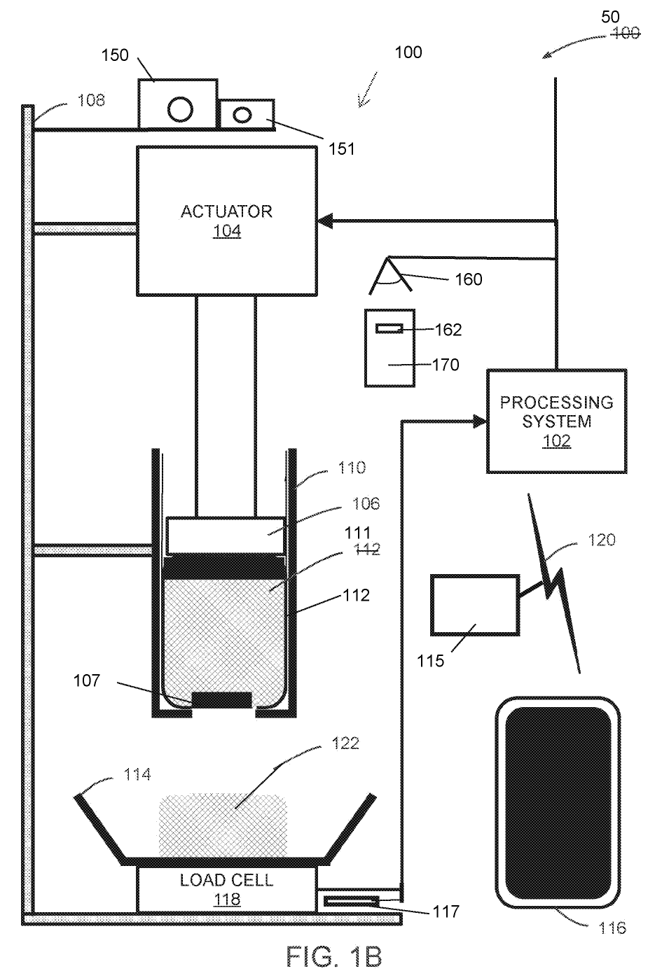

FIG. 1A is a schematic diagram depicting an automated pet feeding system 50 comprising an automated pet food dispenser 100 and operation of the automated pet food dispenser 100, in accordance with some embodiments.

The automated pet food dispensing system 50 comprises an automated pet food dispenser 100, a user computing system 116, a remote computing system 115, and a communication link 120. The user computing system 116 may comprise as a mobile computing device, e.g. a smart phone, tablet or watch, for example. Remote computing system 115 may comprise a cloud based computing system, such as Amazon Web Services (AWS). The communication link 120 may comprises any communication link from the user computing system 116 to a processing system of the automated pet food dispenser. The communication link may comprise a direct link between the user computing device and the processing system of the pet food dispenser, e.g. with Bluetooth, or an indirect link through an intermediate device, such as via the remote computing system, e.g. with internet communication. The configuration of system 50 allows a user to control operation of the automated pet food dispenser 100 while the user is away.

As depicted, automated pet food dispenser 100 includes processing system 102, actuator 104, backstay 105, plunger 106, nozzle 107, support 108, receptacle 110, pet food 111, pet food container 112, food bowl 114, computing system 116, heating element 117, load cell 118, camera 150, an illuminator 151, a code reader 160, a code 162, and a second pet food container 170. In some embodiments, the pet food container 112 comprises the backstay 105 and the nozzle 107. The container 112 may be any suitable size or shape, such as a cannister, for example.

In some embodiments, a heating element 117 is operatively coupled to the processing system 102 and located in proximity to the pet food bowl 114 to heat dispensed pet food. The heated food, such as heated wet food, may provide improved olfactory stimulation and encourage an older cat to eat. Alternatively or in combination, the pet feeding experience can be improved, for example the food in the feeding container can be heated to approximately body temperature, such that the food may appear to be fresher than unheated food. While the cold wet food dispensed from the container can be heated to any suitable temperature range, in some embodiments the processor coupled to the heating element is configured to heat the food to a temperature within a range from about 30 degrees Celsius (C) to about 45 degrees C, for example within a range from about 33 degrees C to about 42 degrees C.

In some embodiments, the backstay 105 is configured to engage plunger 106 to dispense wet pet food 111. The backstay 105 may comprise one or more seals such as an O-ring or a crown seal, for example. The backstay 105 is configured to slide along an interior of the container to induce wet pet food 111 to flow through an outlet 107 of container 112. In some embodiments, the backstay 105 comprises a stiff, substantially rigid material, in order to resist deformation when engaged by plunger 106. In some embodiments, the backstay 105 comprises a beveled portion to guide a distal end of plunger 106 into an alignment with a central axis of the wet pet food container 112. This can help to stabilize the wet pet food container when subjected to forces from the plunger 106.

In some embodiments the plunger comprises a beveled engagement structure, such as beveled annular engagement structure, to engage a beveled engagement structure on the backstay, such as an annular beveled engagement structure on the back stay, which can help to self-center the plunger with the backstay and improve accuracy of the amount of food delivered as described herein. In some embodiments the engagement structure of the plunger mates with the engagement structure of the backstay, for example. In some embodiments, the engagement structures are configured to align an axis of the plunger with an axis of the wet pet food container when the plunger engages the wet pet food container, for example with the backstay of the wet pet food container.

The outlet 107 may comprise an orifice or seal, for example, which is configured to dispense pet food onto food bowl 114. The outlet 107 can be configured in many ways and may comprise a small orifice to release wet pet food. Alternatively or in combination, outlet 107 may comprise a seal that opens upon pressurization of the wet pet food container and closes when the wet pet food is no longer pressurized. In some embodiments, the outlet 107 comprises a hydrophobic material, such as plastic or silicone, to decrease the deposition of residual wet pet food material on the outlet. In some embodiments, the wet pet food container comprises an elastically deformable material that is configured to increase a size of the orifice when wet pet food flows through the orifice and decrease the size of the orifice when the wet pet food no longer flows through the orifice.

In some embodiments camera 150 is configured to image the pet, e.g. a face of the pet, when the pet is in proximity to the automated pet feeder. In some embodiments, the camera comprises sufficient resolution to perform facial recognition on captured images. The camera 150 is coupled to processing system 102 in order to store and transmit digital images of the pet. The camera 150 may comprise any suitable camera such as an infrared camera, a black an white camera, a grey scale camera, a color camera, and combinations thereof.

In some embodiments, illuminator 151 is configured to illuminate the pet. The illuminator 151 may comprise any suitable source of illumination such as a light emitting diode (LED), or a light bulb, for example. The illuminator 151 is configured to emit light at wavelengths that can be detected by camera 150. In some embodiments, illuminator 151 comprises an infrared LED. In some embodiments, illuminator 151 comprises an infrared light emitting diode. Alternatively or in combination, illuminator 151 can be configured to emit white light, such as with a white light LED.

In some embodiments, the automated pet feeder comprises a code reader 160 to read a code 162 on a pet food container. The readable code 162 may comprise any suitable code, such as a bar code, a quick response (QR) code, or a radio frequency identification (RFID) code. The code reader 160 may comprise any suitable reader, such as a camera, line scan camera, or an RFID reader. In some embodiments, the code reader comprises an illuminator, such as an infrared illuminator, to illuminate the code on the container. In some embodiments, code 162 comprises a unique identification code, which is associated with a specific pet food container. The code 162 on the container 170 can be associated with the unique identification code of the pet feeder stored on the processing system, to ensure that the correct pet food container is provided to the correct automatic feeder.

While the machine readable code 162 can be placed anywhere on container 170, in some embodiments, code 162 is place on the container at a location that cannot be read when food is dispensed. For example, code 162 can be placed on a backstay such as backstay 105.

In some embodiments, container 170 comprises a second container to be dispensed and the container 112 comprises a first container to be dispensed. The code reader 160 is configured to read code 162 prior to placing the food container 170 into position for dispensing, for example prior to rotating the container 170 into position with a carousel as described herein. This approach can facilitate a more compact form factor of the pet food dispenser, for example.

In some embodiments, the processing system 102 stores a code, such as a unique identifier, which identifies the automatic pet feeder.

Although reference is made to a code on the container, in some embodiments, the wet pet food dispenser is configured to operate without a code on the wet pet food container, for example with reusable containers. In some embodiments, the reusable container comprises a threaded end cap that screws onto threads on the distal end of the container to allow removal and replacement of the outlet and end cap. Once removed, the backstay can be pushed out for cleaning, for example in a dishwasher. In some embodiments, the sidewall comprises stainless steel, for example.

In some embodiments, support 108 is substantially rigidly mechanically connected to actuator 104 and receptacle 110. Receptacle 110 may be configured to receive and store pet food container 112. Pet food container 112 may be filled with wet pet food. In an aspect, a pet food container such as pet food container 112 may also be referred to as a “cartridge.” Pet food container 112 may also be substantially sealed to appropriately preserve the contained wet pet food for a specified amount of time. In some embodiments, the wet pet food can be preserved for a period of 4 months to 3 years, depending on factors such as sealing of pet food container 112, and environmental factors such as ambient temperature and humidity.

In some embodiments, the receptacle 110 comprises an opening to pass dispensed food from an outlet on a distal end of the container 112 with a clear path from the outlet to the food receptacle.

In some embodiments, processing system 102 is configured to control actuator 104 and extend or retract plunger 106. Plunger 106 may be extended by actuator 104 to apply a pressure or force on pet food container 112. As a result of this force, the sealed pet food container 112 (or cartridge) may rupture or puncture and dispense a part of or the entire contents of pet food container 112 into food bowl 114. A pet may be able to consume the dispensed wet pet food from food bowl 114. Food bowl 114 may be a pet food bowl. As depicted in FIG. 1A, plunger 106 is in a fully-retracted position.

In some embodiments, actuator 104 is a linear actuator (e.g., a lead screw linear actuator) In other aspects, actuator 104 may be a pneumatic actuator, a hydraulic actuator, or a rigid chain-based actuator.

In some embodiments, the plunger 106, the backstay 105, and the outlet 107 are aligned along an axis 109. In some embodiments, one or more of the plunger 106 or the backstay 105 comprises an engagement structure to place the container 112 into an aligned configuration when the plunger engages the backstay and the receptacle supporting the container is placed in a dispensing location, for example. The one or more engagement structures may comprise a rounded or beveled edge, for example with an annular shape profile, as describe herein. In some embodiments, the backstay 105 comprises a recess sized and shaped to receive the engagement structure on the backstay to urge a proximal end of the wet pet food container into alignment with the plunger. In some embodiments, this allows the wet pet food to fall along an unobstructed path from the outlet to food bowl, which can improve the accuracy of the amount of food dispensed from the container. In some embodiments, axis 109 is located along a central axis of the plunger 106. In some embodiments, the axis 109 is located along a center of outlet 109. In some embodiments, axis 109 is aligned with a center of the pet feeding tray. In some embodiments, the engagement structure is configured to align a center of the backstay with a center of the plunger along axis 109.

In some embodiments, the actuator 104 comprises one or more sensors to detect loading of the actuator and the processor is configured to stop driving the plunger in response to an amount of loading of the plunger, e.g. or an amount of power draw from the actuator above a threshold amount, for example. In other words, the processor coupled to the actuator may comprises a fail save configuration, so that the actuator does not become damaged in response to the plunger not moving appropriately, for example if the outlet becomes clogged. In some embodiments, the dispenser processing system is configured to communicate a fault to a user computing system 116, such as a notification pushed to system 116 from processor 102, e.g. pushed to a user interface of user computing system 116.

In some embodiments, the actuator coupled to the tray that opens and closes the tray upon which feeding receptacle 114 is supported comprises one or more sensors to detect loading of the actuator and the processor is configured to stop driving the tray in response to an amount of loading of the actuator, e.g. or an amount of power draw from the actuator above a threshold amount, for example. In other words, the processor coupled to the actuator may comprises a fail save configuration, so that the actuator does not become damaged in response to the tray not moving appropriately, for example if a pet is blocking extension or retraction, i.e. opening or closing, of the tray. In some embodiments, the processor is configured to stop extending the tray if a pet’s limb or paw is blocking the tray, for example. In some embodiments, the processor is configured to stop retracting the tray, for example if pet’s a paw were to be placed on the tray during retraction. In some embodiments, the dispenser processing system is configured to communicate a fault to a user computing system 116, such as a notification pushed to system 116 from processor 102, e.g. pushed to a user interface of user computing system 116.

In some embodiments, load cell 118 measures an amount of dispensed wet pet food in food bowl 114. Processing system 102 may be configured to receive a measurement of the amount of dispensed wet pet food from load cell 118. If the measured dispensed amount of wet pet food is greater than or equal to a predetermined amount, then processing system 102 may command actuator 104 to retract plunger 106. In this way, a known quantity of wet pet food is dispensed from pet food container 112. This enables a user to control an amount of wet pet food dispensed for a particular meal. In some embodiments, meals are customizable and can be configured by a pet owner (i.e., a user). A typical meal might weigh 2-3 oz of wet pet food for an average cat. A feeding frequency of 2-4 meals per day may be programmed into processing system 102, depending on a size or weight of the pet. For dogs, a daily amount of 3 oz of wet pet food may be dispensed by automated pet food dispenser 100 for each 3-3.5 pounds of body weight of a dog.

In some embodiments, the user interface of the user computing system 116 is configured to a user to adjust an amount of food dispensed at a each of a plurality of pet feeding events, and this data is transmitted to processing system 102 as described herein. In some embodiments, the average meal size is within a range from about 0.3 ounces (oz) to about 1.5 ounces, for example within an range from about 0.5 oz to about 1.0 oz, depending on animal size, e.g. cat size and nutritional requirements, and the frequency of daily pet feeding events is within a range from about 4 to 12 meals per day, for example within a range to about 5 to 10 feeding events per day, i.e. meals per day. In some embodiments, the interface of the user device is configured to adjust both the amount of food at a feeding event and the number of feeding events per day. In some embodiments, the user interface is configured for the user to adjust the amount of food dispensed at the daily feeding events and the frequency of the feeding events. In some embodiments, the user interface is configured for the user to adjust the amount of food dispensed at each of a plurality of daily feeding events and the frequency of said each of the plurality of pet feeding events. In other words, the user interface is configured for the user to input the amount of food dispensed at each daily feeding event, so that the amount of food dispensed is different during the morning and afternoon, for example. In some embodiments, the user interface is configured to allow the user to specify a time of feeding at each of the plurality of pet feeding events. This approach allows the user to input into the user interface the time of each daily feeding event and an amount of food dispensed at the specified time of each of the plurality of daily pet feeding events.

Processing system 102 may be configured to determine how much food remains in pet food container 112 based on how much plunger 106 is extended. When plunger 106 is extended to a certain length (e.g., 6 inches), processing system 102 may determine that a bottom of plunger 106 may be close to a bottom end of receptacle 110. This, in turn, indicates that pet food container 112 is substantially empty. Processing system 102 may then completely command actuator 104 to completely withdraw plunger 106 from receptacle 110 and container 112. Processing system 102 may also issue one or more user alerts for a user via a user interface, informing the user that pet food container 112 is substantially empty.

In some embodiments, processing system 102 is configured to dispense a predetermined quantity of wet pet food at a given time of day, or dispense predetermined quantities of wet pet food at regular time intervals or at different preset times of day (e.g., 100 grams of wet pet food every eight hours). To achieve these functional aspects, processing system 102 may be appropriately programmed by a user via a user interface. User-programmable functions associated with processing system 102 may include a quantity of wet pet food to be dispensed at a particular meal, one or more feeding times, a feeding time interval, and so on. To implement these functions, processing system 102 may be a microcontroller, a digital signal processor (DSP), a field-programmable gate array (FPGA), a general processing system, a personal computing system, a mobile phone, a tablet, a laptop computer, a desktop computer, or any other similar processing system. As presented herein, processing system 102 generally includes a processor, a memory, and one or more communication interfaces.

While the system 50 can be configured in many ways to provided automated pet food dispensing, in some embodiments, one or more components of the remote computing system 115, user computing system 116, and communication link 120 are configured to communicate with the processing system 102 of the automated pet food dispenser 100, in order to customize feeding of the pet, e.g. provide adaptive feeding to the pet. In some embodiments, one or more user-programmable functions may be input by a user on user computing system 116, and then transmitted to processing system 102 via wireless communication link 120. The user computing system 116 may be any computing device such as a desktop computer, a laptop computer, a mobile phone, a tablet, or any other computing device. Wireless communication link 120 may be implemented in any suitable way, such as a communication link compliant with a Bluetooth® standard protocol, a communication link compliant with a Wi-Fi™ standard protocol, a communication link compliant with a Zigbee standard protocol, an ultrasonic communication link, or as a communication link compliant with any other wireless communication protocol. In some embodiments, computing system 116 may run an application software (app) that allows a user to configure, control, and monitor aspects of automated pet food dispenser 100. In some embodiments, communication link 120 is configured to communicate with pet food dispenser 100 via the remote computing system 115, such as one or more cloud based servers, e.g. with Amazon Web Services (AWS) or any suitable remote computing system.

Any of the computer implemented instructions as described herein can be located one or more of the processing system 102, the computing system 116, or remote computing system 115.

FIG. 1B is a schematic diagram depicting an operation of automated pet food dispenser 100. FIG. 1B depicts automated food dispenser as including processing system 102, actuator 104, plunger 106, support 108, receptacle 110, pet food container 112, food bowl 114, computing system 116, and load cell 118.

As depicted in FIG. 1B, plunger 106 is shown to be extended by actuator 104, to be in an extended position. As plunger 106 is extended by actuator 104 upon command from processing system 102, plunger 106 exerts a force on pet food container 112. The plunger 106 may be a cylindrical rod with a distal end configured to engage a proximal end of the wet ped food container. Pet food container 112 is also physically constrained at a bottom end by receptacle 110. This constraint may be due to a design of receptacle 110, or due to an insert placed into receptacle 110. Due to the forces exerted by plunger 106 and receptacle 110, pet food container 112 may rupture at outlet 107, for example. In some embodiments, pet food container 112 may be designed to rupture at a bottom end so that the wet pet food contained within pet food container 112 is dispensed (or extruded) out into food bowl 114 as dispensed pet food 122. In some embodiments, load cell 118 measures a quantity (e.g., a weight) of dispensed pet food 122. If the weight of dispensed pet food 122 is greater than or equal to a predetermined quantity as programmed into processing system 102, processing system 102 may command actuator 104 to stop extending plunger 106 further, and possibly retract plunger 106 back to a fully-retracted state as shown in FIG. 1A. A pet may now feed from food bowl 114. Since a predetermined quantity of food has been dispensed, underfeeding or overfeeding of the pet may be decreased, for example avoided.

Automated pet feeder 100 may be used on a daily basis for automatically dispensing a known quantity of wet pet food to a pet. For example, when a pet owner goes to work, the pet owner (user) may program processing system to dispense predetermined amounts of pet food at predetermined times while the pet owner is away. In some embodiments, food bowl 114 is removeable for cleaning and sanitizing, and may be replaced with a similar food bowl. In some embodiments, food bowl 114 is attached to load cell 118 via a magnetic coupling. In some embodiments, load cell 118 may be replaced by a similar weight-measuring device.

In some embodiments, the sidewall of the container, the backstay, and the base of the container comprises substantially rigid components, so that these components do not deform when the plunger engages the backstay and pressurizes the pet food within the container. Although reference is made to rigid components, one of ordinary skill in the art will understand that these components are sufficiently rigid so as not to deform during normal use of the wet pet food container in a manner that would affect the accuracy of the amount of food delivered as described herein, although these rigid components may deform when used in an unintended manner, such as being struck by a hammer.

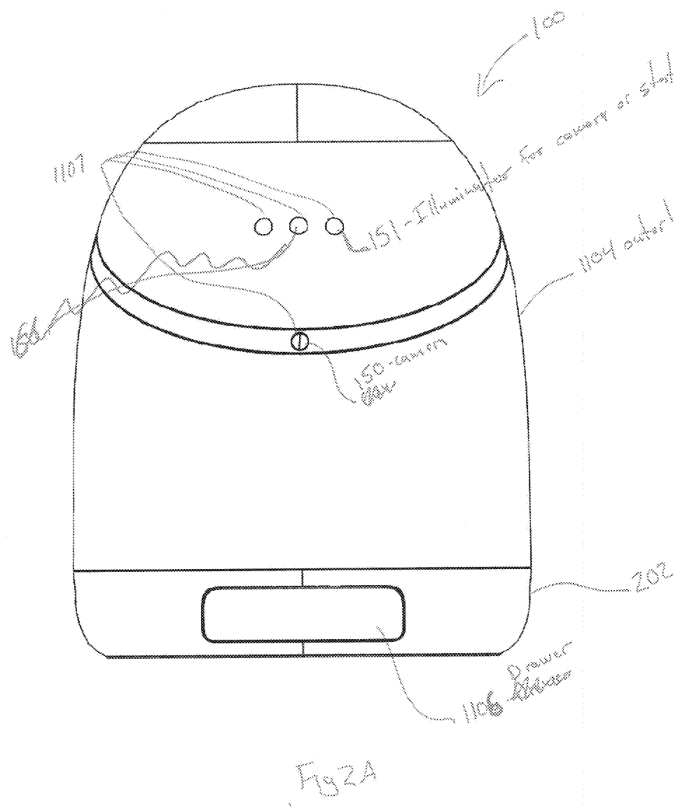

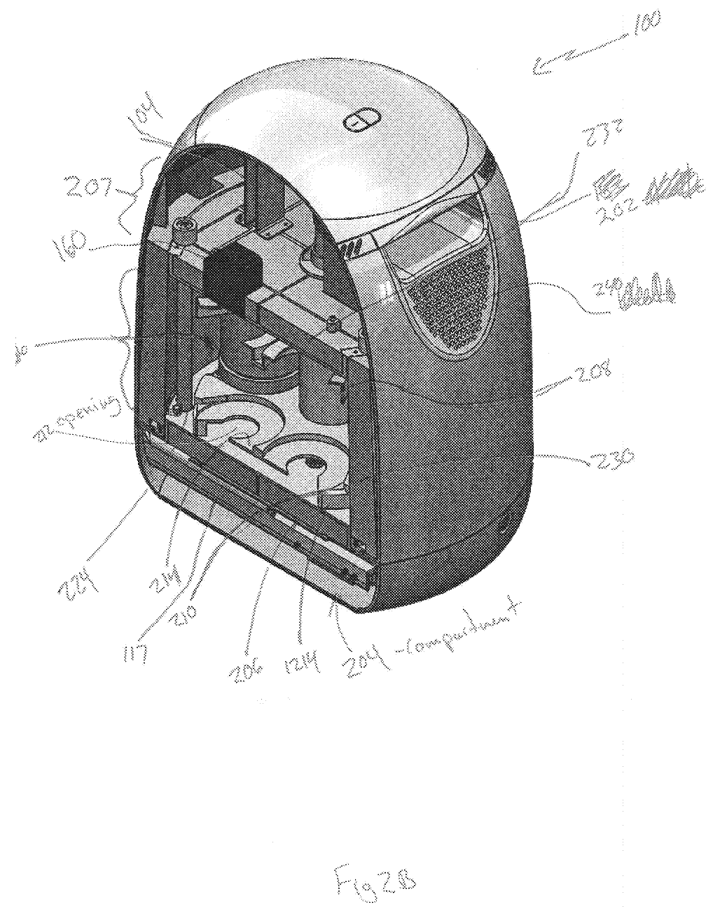

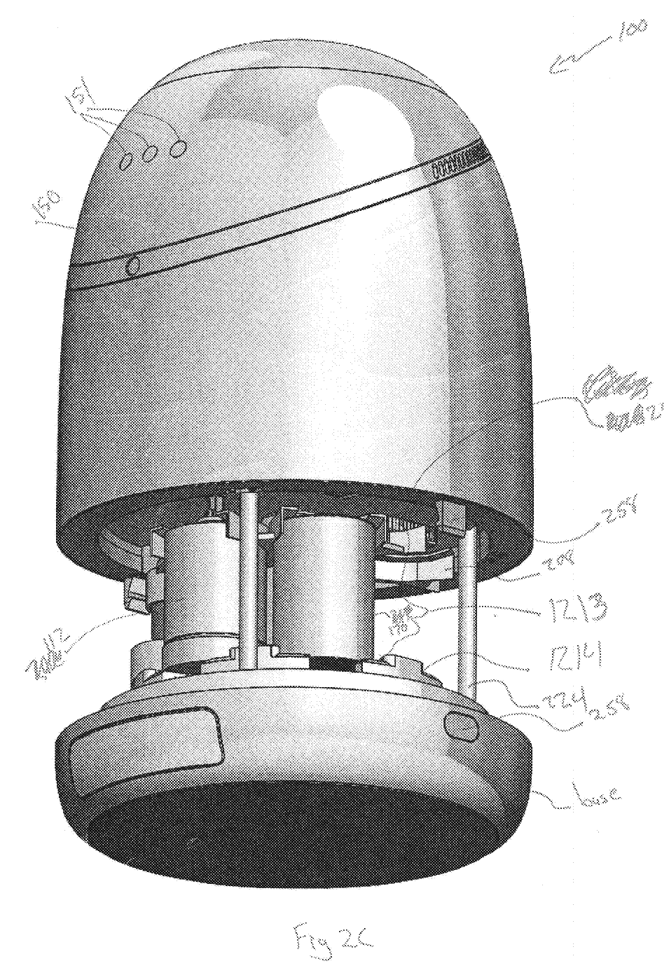

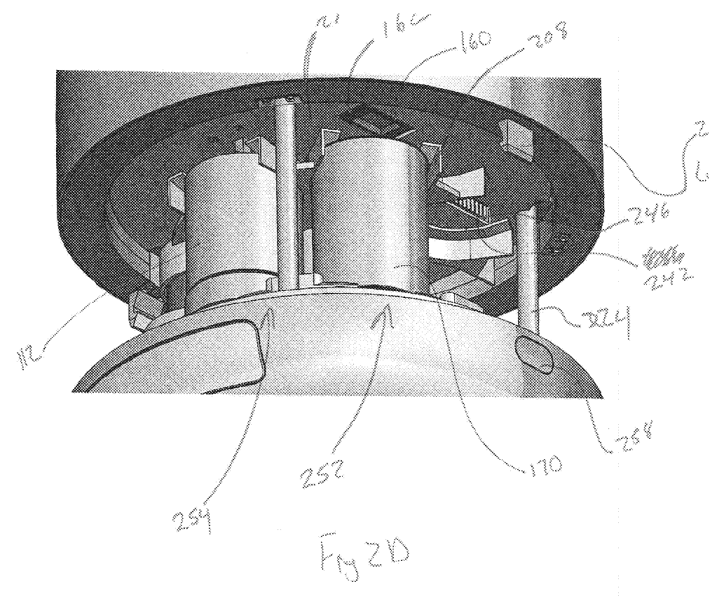

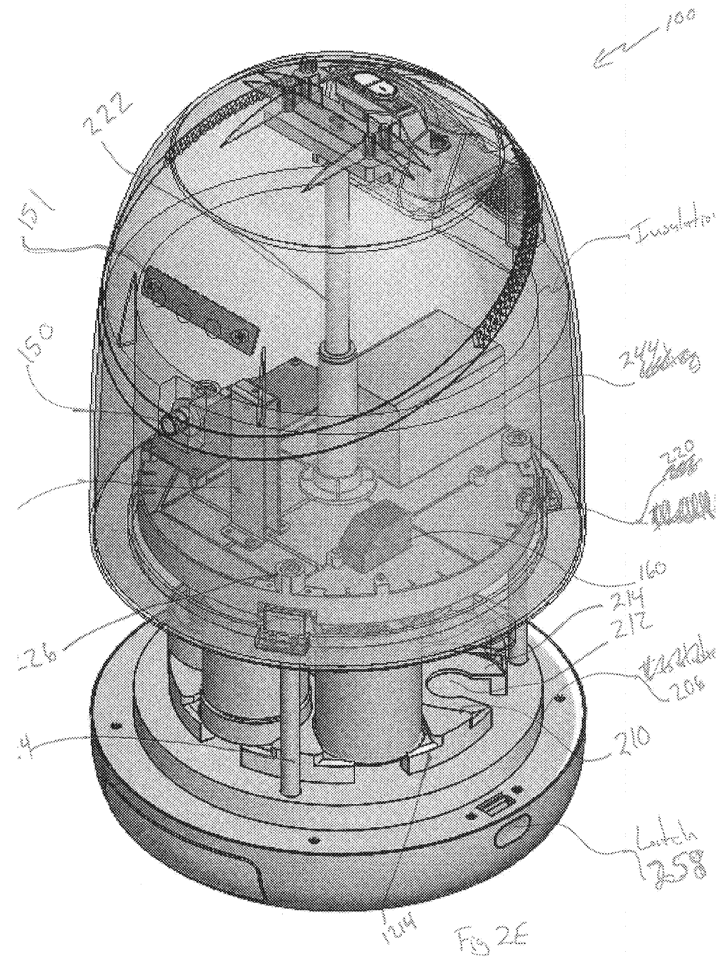

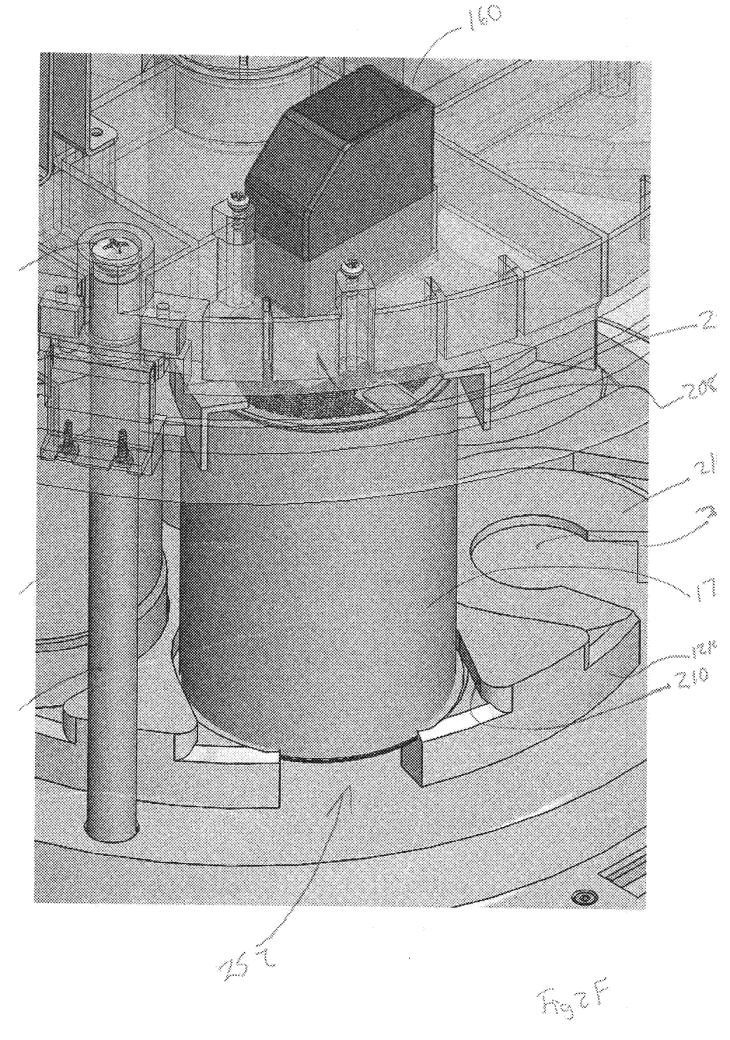

With reference to FIGS. 2A-2F. The lower portion of the dispenser features a broad, rounded base 202 having a flat bottom to provide a stable foundation that curves upward towards the outer perimeter of the base 202. The base forms a compartment that houses food dispensing mechanisms and acts as the structural support for the unit.

The base 202 forms a compartment 204 the feeding drawer 1106, which slides outward during feeding and retracts when not in use. The food or feeding drawer may include a food bowl 114, where food is dispensed from the food container 112. The food bowl ore receptacle may be metal. In some embodiments, a load cell 118 may be located in the drawer and beneath the bowl to measure food weight when the drawer is retreated into the base or extended in the feeding position. In some embodiments, the load cell may be located in the compartment and beneath the bowl, but not part of the drawer, such as located on the base. The load cell 118 may be located beneath the food bowl 114 when the drawer is retracted into the base but not beneath the bowl when the drawer is extended into a feeding position.

In some embodiments, heating element 117 may be located on or in the drawer to warm the dispensed wet food to improve palatability for the pets. In some embodiments, a heating element 117 may be located in the drawer and beneath, surrounding, or both beneath and surrounding the bowl to heat dispended food when the drawer is retreated into the base or extended in the feeding position. In some embodiments, the heating element 117 may be located in the compartment and beneath the bowl, but not part of the drawer, such as located on the base. The heating element 117 may be located beneath the heating element 117 when the drawer is retracted into the base but not beneath the bowl when the drawer is extended into a feeding position. In some embodiments, the heating elements may be a Peliter heater, resistance heaters, induction heaters, or convention heaters. Peltier heaters use the thermoelectric effect to create a temperature differential when electric current flows through the junction of two different conductors. One side becomes hot while the other side becomes cold. These devices are compact, have no moving parts, and can both heat and cool depending on the current direction. Resistance heaters convert electrical energy into heat via resistive materials, such as nichrome wire or etched foil elements. Convection heating involves warming air and allowing it to circulate around the food bowl. This can be achieved either through natural convection or by using a fan to force air movement. Induction heating works by generating a high-frequency alternating magnetic field using a coil. When a conductive material is placed within this field, eddy currents are induced in the material. These currents generate heat due to the material’s electrical resistance and magnetic hysteresis. This method heats the bowl material directly, rather than relying on conduction or convection from an external heat source.

The heating element 117 may be located beneath the bowl’s base, wrapped around the walls of the bowl, or both. The heating element 117 may be in contact with the food receptacle. In some embodiments, such as with a convection heater, may be located in the base, the upper portion of the dispenser 100, or elsewhere. The hot air from the heater may be ducted into the heating chamber using hot air ducts.

The base may include a drawer actuator assembly, such as, for example, electric motor 1510 and rack-and-pinion mechanism 1412. The electric motor may be a compact DC electric motor under control of the processing system 102 form which it receives commands form the processing system to begin and, in some embodiments, end actuation cycles to extend the drawer into a feeding position and retract the drawers into the base. The drawer actuator assembly may include a linear actuation system, such as the rack-and-pinion mechanism 1412. The rack-and-pinion mechanism 1412 converts rotary motion of the motor into linear translation of the drawer. In some embodiments, the drawer actuator assembly may include a screw-driving actuator, such as a lead screw or ball screw. These actuators use a motor such as a DC or stepper moto) to rotate a screw, which in turn moves a nut, which may be attached to the drawer, linearly along the screw. In some embodiments, the actuator may be a belt driven actuator wherein a motor is coupled to a cog, gear, wheel, or other rotating device that engages a belt. The belt may be coupled to the drawer. Movement of the motor causes the belt to move which results in the drawer moving.

The drawer may also include linear guides or rails that aid in ensuring the drawer slides along a linear path and also aids in limiting wobble or misalignment of the drawer. In some embodiments, the guides or rails may be molded into and/or attached to the base and/or the drawer.

The actuator assembly may be coupled in electronic communication with the processing system (102) such that it operates under software control that considers both time and sensor data to trigger the beginning and end of feeding events. For example, triggers for beginning or resuming a feeding event may cause the drawer to extend at the beginning of a scheduled feeding time, upon identification, such as via facial recognition, or a pet, or through commands received, such as via the user computer system 116. Triggers for the ending or pausing of a feeding time may includes an ending time for feeding, an elapsed time for feeding, load cell data indicating adequate consumption of the dispensed food, or other sensor data indicating a pet has left the feeding area and/or another pet has entered the feeding area. Other sensors, such as a vibratory sensor may indicate that a pet has begun eating or ceased eating which may result in the drawer remaining open or retraction of the drawer, respectively.

The compartment 204 may also include a carousel actuator assembly. The carousel actuator assembly in the automated pet food dispenser may be an electro-mechanical subsystem responsible for rotating the multi-container carousel, allowing the dispenser to select and align individual pet food containers with the dispensing mechanism for dispending of food into the food bowl. This aids in providing multi-day and multi-meal automated feeding schedules.

The carousel actuator assembly may include a carousel motor, such as carousel motor 1802 and a rotating element, such as Genevia drive 1804 that is coupled to the rotatable carousel 1214.

The electric motor may be a compact, processor-controlled DC motor, a stepper motor or other or other device that provides rotational drive to the carousel either directly or through a coupling mechanism, such as a gearbox, belt drive, or other system. For example, a Geneva drive or other indexed rotation mechanism that provides rotational steps (e.g., 60° steps per movement for a 6-container carousel). In some embodiments, the actuator system may provide positive locking at each position to ensure accurate container alignment.

The upper portion of the compartment 204 may include an insulated divider between the chamber 204 of the base 202 and the food compartment 206. The insulated divider may be thermal partition, also referred to as the thermal bulkhead such as thermal bulkhead 1306 that may be both a structural and a thermal structure that aids in maintaining distinct temperature zones within the single compact vertical housing of the pet food dispenser, such as keeping the cool side plenum 1308 of the food compartment 206 cool while heating the base hot side plenum 1302 of the lower compartment 204.

The purpose of the insulated divider 206 is to aid in minimizing heat conduction and airflow exchange between these compartments to allow for reliable and consistent refrigeration of food containers within the food compartment 206 for the preservation of freshness and safety of sealed wet food while allowing for efficient heating of the food in the lower compartment.

The thermal partition may comprise multi-layered materials selected for both low thermal conductivity and structural rigidity. Materials may include a rigid insulation core layer of expanded polystyrene (EPS), polyurethane foam, or aerogel panels, or other materials that provide high thermal resistance, low weight, and structural rigidity, such as resistance to deformation. Material may also include a reflective heat layer, such as a foil-based or metallized polymer layer (e.g., Mylar) that may line one or both sides of the bulkhead to reflect infrared heat from the hot side downward back into the lower compartment 204 and/or otherwise reduce radiant heat transfer.

The thermal partition may be thermally decoupled from other components of the pet food dispensing system. For example, the partition may be mechanically and/or thermally isolated from adjacent components using insulating gaskets, bushings, or air gaps to minimize conduction via contact points. For example, the edges of the partition may include compressible foam gaskets, O-ring channels and O-rings, or snap-fit thermal flanges to form an airtight or semi-sealed fit within the dispenser chassis.

The thermal partition 206 may be horizontally oriented, spanning a horizontal cross-section of the dispenser interior just above the lower compartment 204 and directly beneath the carousel assembly.

The thermal partition may include an opening for dispensed food to pass from the upper compartment to the food bowl in the lower compartment. The opening may include a door, shutter, or other structure to open and close and/or cover the opening when food is not being dispensed.

The food compartment 206 may be a vertically oriented enclosure located above the thermal partition 1306 and the lower compartment 204 and serves as a thermally controlled chamber for storing a plurality of wet pet food containers 112. It includes the carousel 1214 and portions of the dispensing mechanism, including the actuator 104 and plunger 106.

In some embodiments, the carousel may be housed entirely within the refrigerated compartment 206. The carousel includes a plurality of receptacles 1213, each precisely dimensioned to hold a wet pet food container 112. The carousel may hold 3, 4, 5, 6, 7, 8, or more pet food containers 112. The carousel may be mounted horizontally on a vertically extending rotational axis. The carousel may index the one or more containers, one at a time, into alignment with the plunger 106 for dispending food into the food bowl.

The receptacles provide secure lateral and vertical support for each container. The receptacles include upper and lower guides 208, 210 for receiving the top and bottom of the containers 112, respectively. Each receptacle may include a platform 214 on which a container 112 may rest. The platform may include an opening 212 through which food may be dispensed from the container to the bowl.

The food compartment may include insulated sidewalls 230 and top 232. The insulated sidewalls 230 and top 232 may aid in minimizing heat conduction and airflow exchange between the food compartment and the rest of the food dispenser and the external environment to allow for reliable and consistent refrigeration of food containers within the food compartment 206.

The insulated sidewalls 230 and top 232 may include multi-layered materials selected for both low thermal conductivity and structural rigidity. Materials may include a rigid insulation core layer of expanded polystyrene (EPS), polyurethane foam, or aerogel panels, or other materials that provide high thermal resistance, low weight, and structural rigidity, such as resistance to deformation. Material may also include a reflective heat layer, such as a foil-based or metallized polymer layer (e.g., Mylar) that may line one or both sides of the insulated sidewalls 230 and top 232 to reflect infrared heat away from the food compartment 206 and/or otherwise reduce radiant heat transfer.

The insulated sidewalls 230 and top 232 may be thermally decoupled from other components of the pet food dispensing system. For example, the insulated sidewalls 230 and top 232 may be mechanically and/or thermally isolated from adjacent components using insulating gaskets, bushings, or air gaps to minimize conduction via contact points. For example, the edges of the partition may include compressible foam gaskets, O-ring channels and O-rings, or snap-fit thermal flanges to form an airtight or semi-sealed fit within the dispenser chassis.

The insulated top 232 may be horizontally oriented, spanning a horizontal cross-section of the dispenser interior at the top of the food compartment 204. The insulated sidewalls 230 may extend from the lower partition 206 to the top 232.

The insulated sidewalls 230 and top 232 may include an opening 242 for the cold side of the cooling unit 244 to allow the cooling system to remove thermal energy from the food compartment 206 and expel it though vents 240 to the external environment.

The cooling unit 244 may be located in the upper compartment 207 of the automated food dispenser 100. The cooling unity 244 may be located within or adjacent to the upper housing and is thermally coupled to the food chamber. The cooling unit may include a thermoelectric cooler (TEC) module (e.g., Peltier element) or heat pump to extract heat from the chamber. A heatsink and fan on the hot side of the cooling unity 244 may exhaust heat energy though the vent 240 into the external environment.

In some embodiments, one or more circulation fans inside the food compartment may promote uniform airflow past the cold side heat sink 246 and past the food containers 112. Temperature sensors may provide feedback to the processing system 102 to maintain chamber temperature within a preset range, typically below ambient but above freezing, e.g., between 2° C and 8° C, preferably between 2° C and 4° C.

The code reader 160 may be located in the upper compartment 207 above the food compartment 206. The code reader may positioned above an aperture 162 in the top 232 of the food compartment 206. The code reader may be in a location above a carousel food container position 252 adjacent to the dispensing position 254. The position 252 may be the container identifying position. This arrangement aids in identifying the container before it is moved into the dispensing position. In some embodiments, the code reader includes an illuminator to illuminate the code 162.

During use, the processing system 102 may move the carousel to place a food container 112 into the identifying position 252. Then the code reader 160 may read a code 256 located on a top portion of the food container 112. The processing system 102 verifies the code and/or authenticates the case, such as, for example, based on data in a remote database. The processing system may also identify the type of food in the food container 112 and if it is an appropriate food for feeding a pet, may rotate the container into alignment with the dispensing system plunger 102 for dispensing food into the food bowl.

The outer housing 1104 of the automated pet food dispenser 100 includes one or more specialized sensor and optical ports which may be small, purpose-designed openings or windows that allow sensors and vision systems to interface with the surrounding environment. These sensors and vision systems aid in pet identification, food dispensing and drawer control, and environmental monitoring.

A first port or ports 1107 may be a camera vision port that is aligned with an internal camera module 150. The internal camera module may have a field of view that includes the food drawer and/or food bowl and the surrounding environment. The camera module 150 may capture images and provide them to the processing system 103 to aid in the performance of pet facial recognition using trained AI models (e.g., CNNs), detect motion or presence of a pet near the feeder, control and tray extension and retraction based on proximity or identity of a one or more pets near the feeder, and to record feeding events for behavioral analysis or owner review.

The camera vision port may include a transparent or semi-transparent window built into the housing wall that offers optical clarity and transmittance in one or more spectral ranges while blocking dust and moisture from entering the device. The window may be made from visual light and/or infrared-transmissive plastics.

In some embodiments, the window may include one or more coatings, such as multi-layered coatings to provide anti-reflective and/or hydrophobic properties. Coatings may also provide resistance to scratching and for use with dual-spectrum cameras that capture in the visible and IR wavelengths of light.

A second port or ports 1107 may be aligned with an IR illuminator 151. The IR illuminator may provide illumination invisible to pets and humans to assist the internal camera in low-light or dark environments. In some embodiments, the IR illuminator 151 aids pet recognition algorithms by providing consistent image data across varying lighting conditions.

The IR illuminator may include one or more LEDs which may emit light in a range of 820-880 nm, preferably about 850 nm, such as for brighter IR image capture and/or in the 910-970 nm range, such as about 940 nm, which is less visible to humas. In some embodiments, the IR emitter may include an array of IR emitters of the same or different wavelengths of light. In some embodiments, the IR emitters and/or a window aligned with the second port 1107 may include a diffuser to provide uniform lighting across a wide field of view.

In some embodiments, the IR emitter may include a structured light illuminator for depth mapping. In some embodiments, IR images capturing structured light may aid in depth mapping of the area surrounding the dispenser and pet identification. For example, the depth map may aid in determining a shape and a size of a pet to distinguish between one pet and other or between pets and other animals or objects within the field of view camera system 150.

The upper portion of the outer housing 1104 may be movable between a closed position, see FIGS. 2A and 2B, and an open position, see FIGS. 2C-2F. The top of the top 232 and sidewalls 230 of the food compartment 206 may be coupled to and movable with the outer housing. When the upper portion of the outer housing is in the open position, the food compartment 206 is open to the outside of the automatic food dispenser to allow for loading and unloading of food cannisters 112 by sliding them into our out of each carousel receptacle 1213.

One or more guide rods 224 may be coupled or otherwise affixed to the base of the food dispenser. Holes or guides 226 may be coupled or otherwise affixed to the upper portion of the housing. The guide rods and holes cooperate to retain the upper portion of the housing with the base while allowing and guiding the movement of the upper portion of the housing between the open and closed positions.

A latching system 258 may hold the upper portion of the housing to the base in the closed position. The latch may include a hook portion and a catch portion. Each a part of one of either the upper portion of the housing or the base. As depicted in FIGS. 2A – 2F, a fixed hook is located on the upper portion of the housing and a movable catch is located in the base. When the upper portion of the housing is brought down onto the base, the catch in the base catches the hook. To release the upper portion of the from the base, the button is pushed, which moves the catch away from or otherwise disengages the hook to allow the upper portion of the housing to move away form the base into an option position.

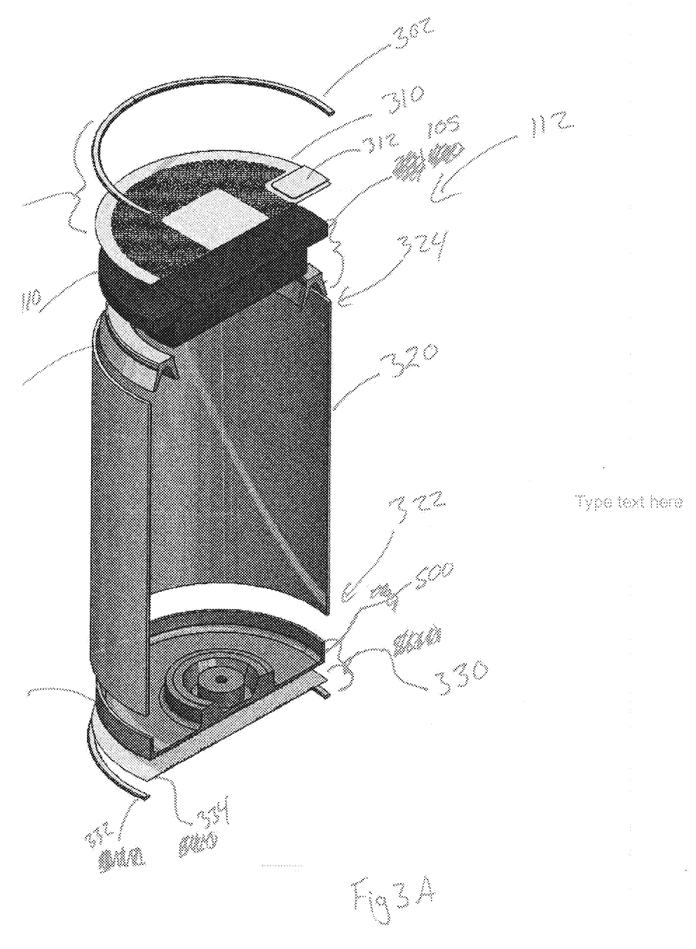

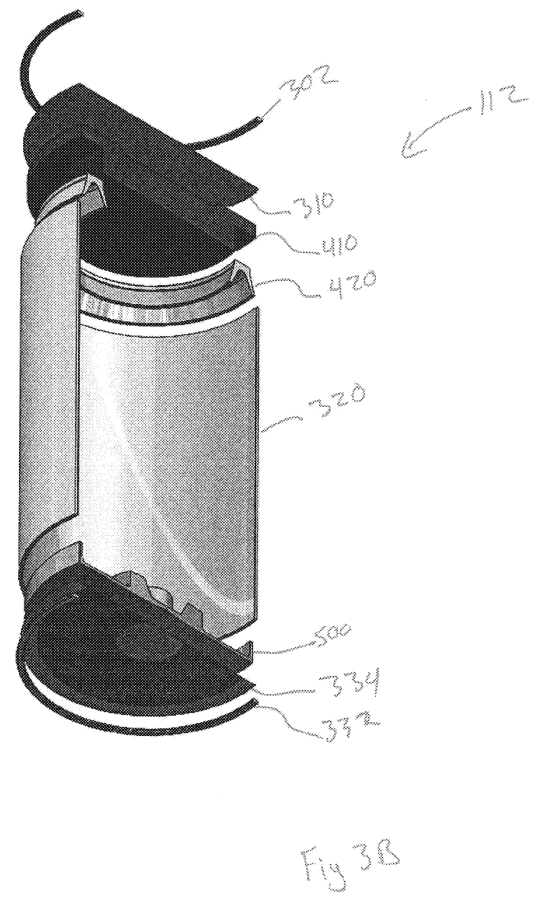

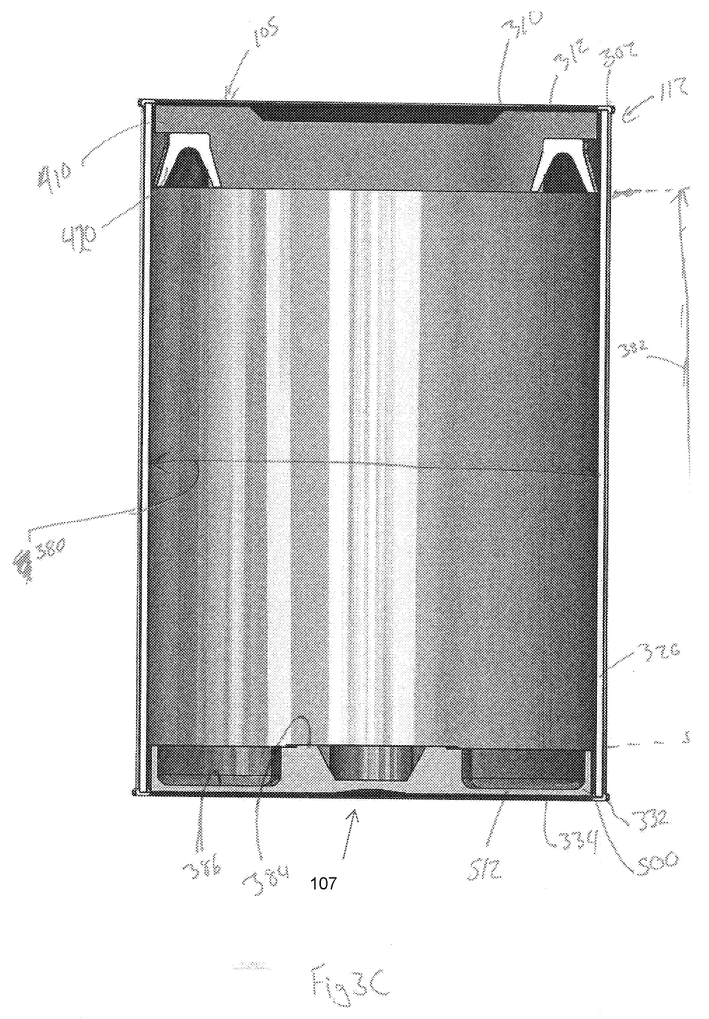

With reference to FIGS. 3A, 3B, and 3C, a food container 112 is depicted. The food container may include a sidewall 320, a back end safety seal 301, a dispensing end safety seal 500, a backstay 105, and a dispensing end comprising insert or cap 500. In some embodiments, the dispensing end comprises a cap configured to be sealed with a sidewall of the container. Alternatively, the dispensing end may comprise an insert placed within the container and supported by a based of the container, for example with an aperture extending through a based of the container.

The sidewall may be cylindrical or annular shaped and extend between a dispensing end 322 and a back end 324 of the food container 112. In some emblements, the back end 322 may be referred to as a proximal end and the dispensing end may be referred to as a distal end.

The back end of the food container 112 may be sealed with a back foil safety seal 301 which may be a removable cover layer. The back foil safety seal 301 may include a foil portion 310 and a sealing ring 302. In some embodiments, the sealing ring 302 may be integral with the foil portion 310. The sealing ring engages with the rim of the back end 324 of the sidewall 320 and with the outer perimeter of the foil portion 310 to seal the back end of the container. To seal the back end 324, the sealing ring 302 engages with the back rim of the sidewall and, if not integrated into the foil, engages with the outer perimeter of the foil portion 310. The ring 302 is then crimped onto the rim of the back sidewall, such as through the use of a double seal. The back foil safety seal may include a pull tab 312 that may be pulled to remove the foil portion of the foil safety seal 301 from the container before use.

Alternative sealing techniques may include heat-sealed laminated foil liners, induction seals, or pressure-sensitive adhesive liners. Materials for the sealing ring may include aluminum, PET-laminated foil, or high-barrier multilayer films for enhanced oxygen and moisture resistance.

The dispensing end of the food container 112 may be sealed with a dispensing end foil safety seal 330. The dispensing end foil safety seal 330 may include a foil portion 334 and a sealing ring 332. In some embodiments, the sealing ring 332 may be integral with the foil portion 334. The sealing ring engages with the rim of the dispensing end 322 of the sidewall 320 and with the outer perimeter of the foil portion 334 to seal the dispensing end of the container. To seal the dispensing end 322, the sealing ring 332 engages with the dispensing rim of the sidewall and, if not integrated into the foil, engages with the outer perimeter of the foil portion 334. The ring 332 is then crimped onto the rim of the dispensing sidewall, such as through the use of a double seal. The dispensing end foil safety seal may be opened before dispensing food. For example, a seal rupture mechanism, such as a half-moon blade, may be pushed into the foil portion 334 to rupture the dispensing end foil safety seal 330 to allow food to be dispensed from the dispensing end of the container 112 into a bowl.

Alternative rupturing mechanisms may include pierceable diaphragms activated by mechanical plungers or rotary punch cutters integrated into the dispenser’s structure. Foil materials may include polyester-aluminum laminates or EVOH-based high-barrier films.

In some embodiments, the food container is configured to be reused. In some embodiments, the cap 500 is configured to be removed from the container for reuse. In some embodiments, the cap 500 comprises threads, or other decouplable mating structures, such that the cap can be removed. In some embodiments, the sidewalls comprises threads to engage the threads on the cap. In some embodiments, the outlet, e.g. the valve, is supported on the cap 500 when the cap has been removed, e.g. unthreaded from the annular sidewall of the container. With the cap removed, the user can push the backstay 105 out of the container 112, so that the backstay 150, sidewall 230 and cap can be cleaned separately, for example washed. In some embodiments, the sidewall 230 comprises stainless steel, for example.

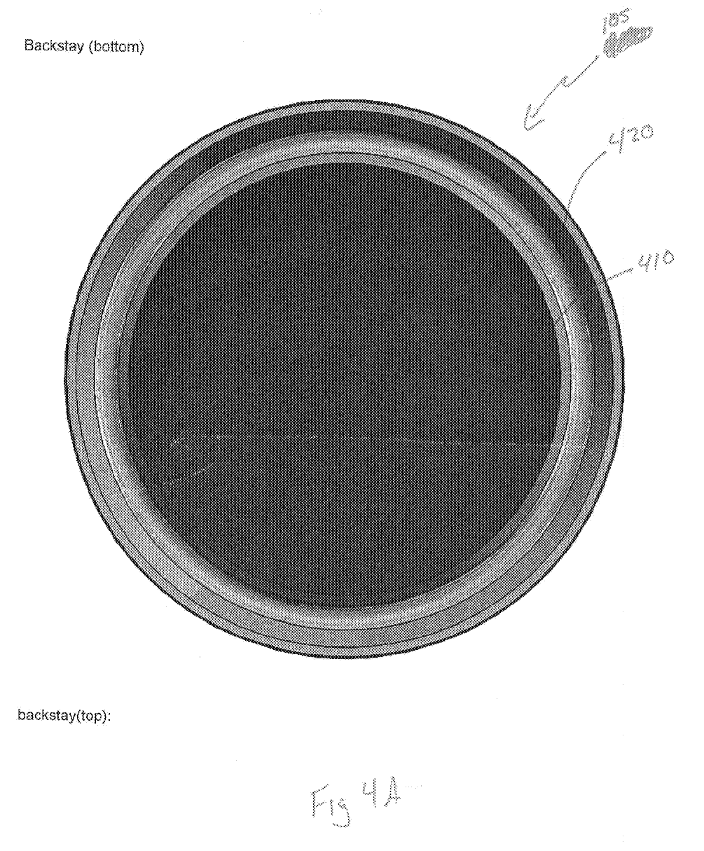

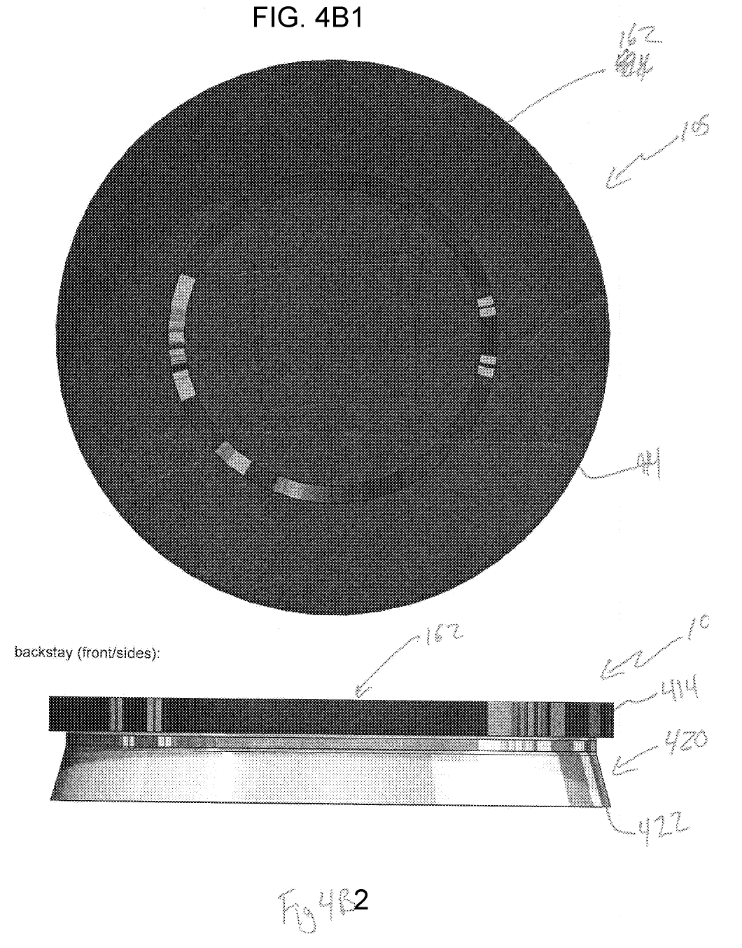

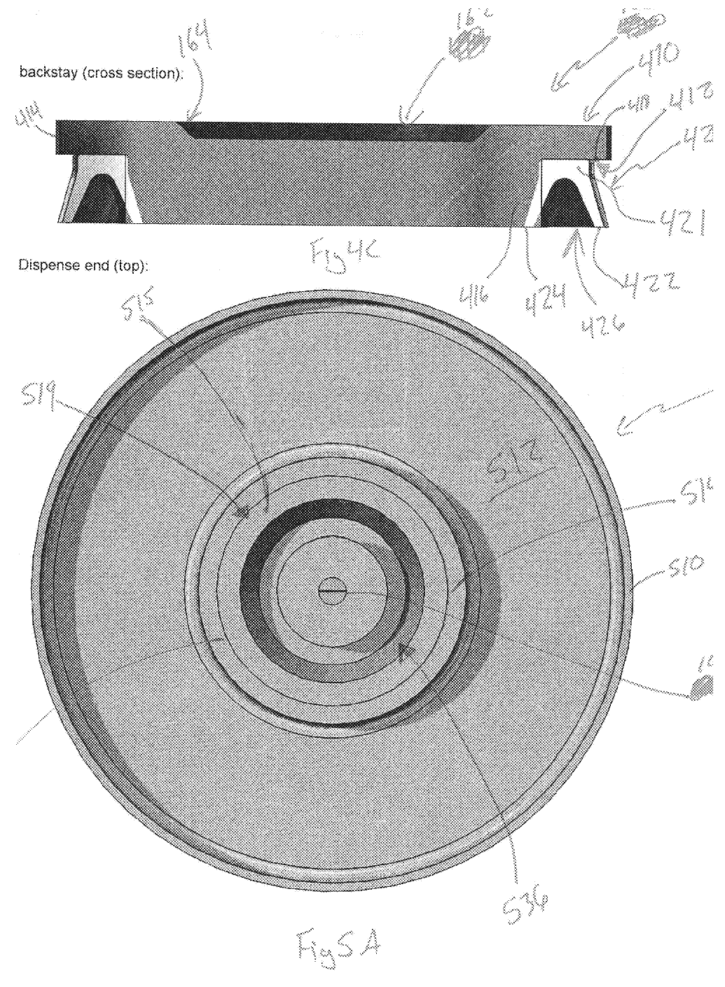

FIGS. 4A, 4B1, 4B2, and 4C depict embodiments of a backstay 105. The backstay 105 may include a backstay body 410 and a gasket or other seal 420. The outer perimeter 414 of the body 410 may have a diameter that is less than an inner diameter of the sidewalls 320 of the container. The body of the backstay may have a sliding or clearance fit with the inner sidewalls 320. The gasket 420 may be fit into a recess 412 formed into the outer perimeter of the body 410. The recess may have a set back perimeter 416, a base 418, and possibly undercuts to help lock the seal in place during plunger engagement.

The seal 420 is captured on the backstay 105 within the recess. The seal may include a base 421 that mates with the base 418 of the body 410. Two annular arms may extend from either side of the base and form a channel therebetween. The distal end of the outer arm 422 may have a diameter greater than the diameters of the outer perimeter 414 of the body 410 and greater than the inner diameter of the sidewalls 320 to provide an interference fit between the outer arm 422 and the inner diameter of the sidewall 320. The outer arm 422 may flex inward when the backstay 105 is inserted into the container 112 to form a seal between the sidewall 320 and the backstay 105. The inner arm 424 may have a diameter that is less than the diameter of the set back perimeter 416 to provide an interference fit between the inner arm 424 and the body 410 of the backstay.

In some embodiments, the gasket 420 may be made from food-safe elastomers such as silicone, EPDM, TPE, or nitrile rubber. Gasket hardness may range from Shore A 10 to 70, with designs tuned for both sealing and glide resistance to accommodate plunger actuation forces.

In this way, the backstay provides a seal between the food within the container and the environment outside the container while allowing for pressure on the backstay, provided by the plunger 106 and actuator 104, to push the backstay towards the dispensing end of the container 112 and push food out of the dispensing end. The actuator and plunger are configured to exert a force on the container within a range of between 20 pounds and 60 pounds, preferably within a range of between 30 pounds and 50 pounds, more preferably, a force of about 40 pounds.

In some embodiments, amounts of force within the ranges described herein are suitable for dispensing different types of wet pet foods, such as pâté, chunky and mousse. In some embodiments, these different types of food can be delivered with the above forces through an appropriately sized opening or valve as described herein, for example with a maximum dimension across of no more than 10 mm, for example.

The processor controls the plunger based on encoder displacement and feedback from a load cell located beneath the food receptacle, achieving dispensing accuracy within one gram and with plunger motion resolution of 0.1 mm (dispensing approximately380 mg per increment). In some embodiments, the accuracy of food dispensing is within 2 grams, 5 grams, or 10 grams. The encoder may be part of the actuator 104.

When assembled, the backstay 105 is contained within the sidewalls of the container. In some embodiments, the backstay does not extend outwardly beyond the back end of the container, such as when the backstay and the identifier are covered with the back end safety foil.

An identifier 162, such as a unique identifier, for the container 112 may be located on or embedded in an external facing surface of the backstay 105. The identifier 162 may be a non-transitory machine readable code.

The identifier may be a printed 2D barcode (e.g., QR), a laser-etched alphanumeric string, or an embedded RFID/NFC tag. In some versions, the identifier may be covered by a removable protective film or seal for tamper-evidence.

. In some embodiments, the identifier is exposed when the back foil safety seal 301 is removed from the container.

In some embodiments, the seal 420 may include a circular O-ring installed within the annular recess 412 of the backstay body 410. The recess 412 may be shaped with a semi-circular or rectangular cross-section to accommodate the O-ring, which is dimensioned to have an outer diameter slightly greater than the inner diameter of the container sidewall 320. When the backstay 105 is inserted into the container 112, the O-ring is radially compressed against the inner wall, creating a tight elastic seal that prevents leakage and maintains internal hygiene. The O-ring, or other seals 420 may be fabricated from food-grade elastomers such as silicone rubber, EPDM, FKM or nitrile, with a Shore A hardness ranging from 10 to 70 depending on the desired sealing force and insertion characteristics. Insertion friction can be reduced by selecting lubricated or PTFE-coated O-rings. In some embodiments, a dual-O-ring setup may be used to provide redundant sealing. The O-ring seal and other seals 420 may also accommodate slight deformations in the container or backstay due to pressure cycling or thermal variation, ensuring consistent sealing over time.

In some embodiments, the backstay may include a recess 164 with a beveled edge. The identifier 162 may be located within the recess. The beveled edge may aid in guiding the plunger into alignment with the backstay when the plunger engages with the backstay. During operation, the process is configured to read the code on the pet food container prior to the pet food container being placed in a dispensing location at least because the plunger is configured to at least partially cover the code on the backstay of the container.

In some embodiments, the processor is configured to read the codes on each container 112 loaded onto the carousel before dispending food from a container. In this way, the oldest can of pet food may be used first, before newer container to, for example, aid in avoiding food waste and to identify each food container within the dispenser. The container information may be provided to the user interface on the user device 116.

In some embodiments, the processor may be configured to move a container 112 away from the dispensing location to a reading location to read the identifier on the container. Then, once read and confirmed, the container may be moved back into a dispensing location. This process may occur after the dispenser is opened, a power loss, or other event that causes uncertainty in the location and contents of container within the system.

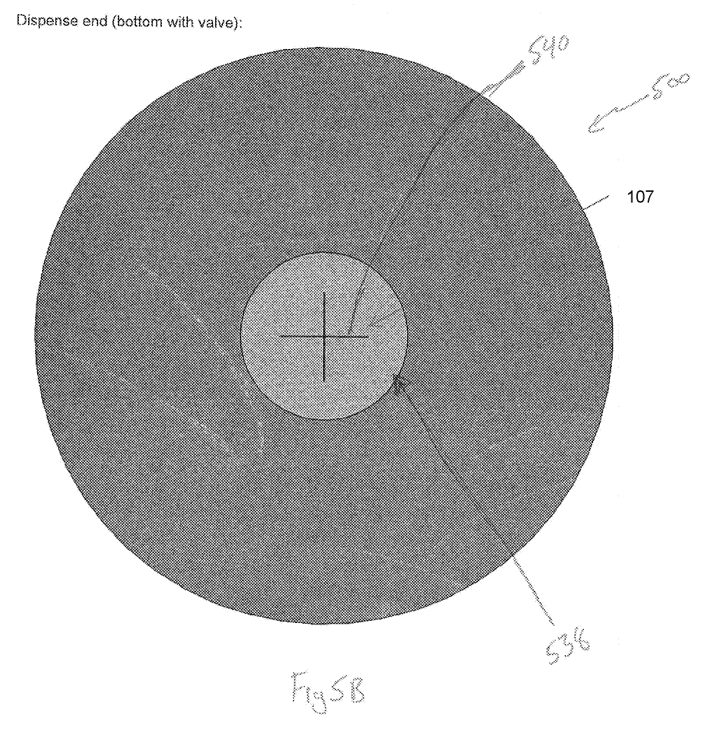

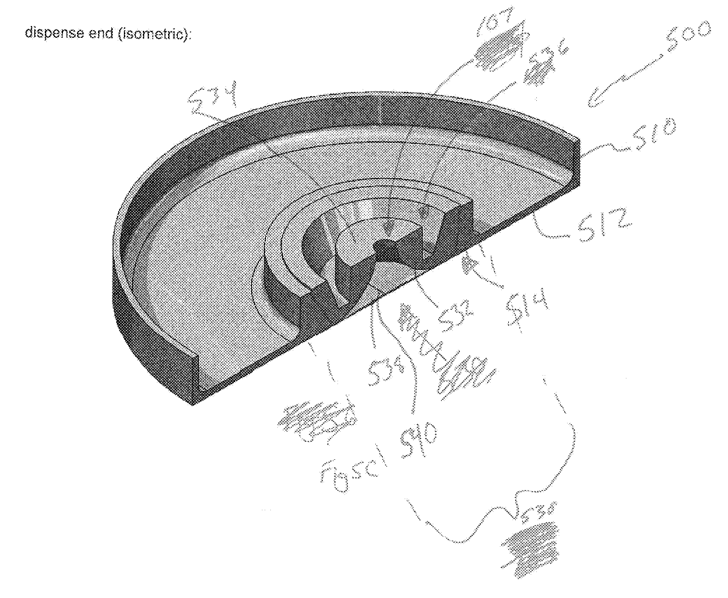

FIGS. 5A, 5B, and 5C depict embodiments of dispensing end insert or cap 500, which may comprise a base. The dispensing end insert or cap 500 is located at the dispensing end 332 of the container 112. The outer perimeter of the end insert or cap 500 may be defined by a sidewall 510 that extends into the container along the inner sidewall of the container. A web or body 512 extends inward from the wall 510 to a nozzle portion 530 of the dispensing end the insert or cap 500. The nozzle portion 530 includes a nozzle 107, which may comprise an aperture in the end of insert or cap 500. The nozzle portion includes a first annular ring 514 at the outer perimeter of the nozzle portion 530 that extends into the container 112. The nozzle portion also includes a second annular ring 534 that also extends into the container. The inner diameter of the inner annular ring 534 defines the aperture of the nozzle 107. The aperture of the nozzle 107 may have a diameter that changes along the length of the nozzle 107. For example, the inner diameter 532 may form a curved profile in cross section with a narrow diameter at an inner end of the nozzle to a wider diameter at an external end of the nozzle.

In some embodiments, the nozzle comprise part of a circular insert 519 that is inserted into the dispensing end of the inert or cap 500. For example, an inner portion 515 of the annular structure 514 may be the outer diameter of the circular insert 519.

The nozzle may be elastically deformable. For example, when the plunger 106 presses on the backstay, the food in the container is pressed against the dispensing end insert or cap 500 which may cause the inner annulus 534 along with the nozzle to be displaced towards the outside of the container. The deflection may be aided by the narrow wall thickness near the exit of the nozzle, such as proximal the bottom of the channel 536. As shown in FIG. 5C, the nozzle diameter near the exit of the nozzle may extend beyond the inner diameter of the channel.

In some embodiments, one or more components of the outlet 107 comprises an elastically deformable food grade silicone comprising a Shore A hardness within a range from about 10 to about 70, for example.

This geometry may be formed by injection molding or thermoforming the nozzle from hydrophobic material. In some embodiments, the material may be elastomeric thermoplastics such as TPU, soft polyolefin blends, or food-grade silicone, for example.

The nozzle portion 530 may include a deformable and self-closing valve 538 that covers the nozzle 107. When pressure is applied to the self-closing valve 538, such as by food being pressed out of the nozzle, the slits 540 of the self-closing valve 538 may separate to open and allow food to pass through. When pressure is released, the slits 540 of the self-closing valve 538 may close, thereby closing the self-closing valve 538.

Valve slits 540 may be formed in cross, star, or petal patterns and cut using die-slitting or laser techniques. The slit dimensions and material Shore hardness (e.g., Shore A within a range from about 10 to about 70, e.g. 30) are selected to achieve a balance between leak resistance and responsive opening under moderate backpressure.

In some embodiments, the outlet comprises a resiliently deformable, hydrophobic elastomeric material with one or more of a valve with slits or an orifice with a maximum dimension across of no more than about 10 mm and optionally no more than about 8 mm.

In some embodiments, the valve comprises a one way valve. In some embodiments, flaps defined by the slits are configured to close over the orifice of the nozzle to resist movement of the wet pet food in a direction opposite the dispensing direction.

The self-closing valve aids in preventing contamination of the food held within the container and not dispensed, allowing the food to be safely stored for longer periods of time, such as up to three days after opening when the container and the food inside remains chilled.

Alternatives to the slit valve include mushroom valves, umbrella valves, or pierceable membrane seals that reseal after compression. Some versions may include antimicrobial additives or coatings to prolong hygiene during multi-day use.

The system supports container configurations that optimize food evacuation efficiency. An inner dimeter 380 of the annular sidewalls 320 and a distance 382 from an upper surface of the nozzle exit 384 prior to engagement with the plunger are configured to deliver at least about 95% of the food present in the cannister prior to the plunger engaging the backstay. With about less than 5% of the volume of food within the container 112 remaining in a volume between the upper surface of the nozzle exit 384 and an inner surface 386 of the web 512.

As discussed herein, the automated pet food dispensing system 50 is designed to store, identify, validate, and dispense wet pet food in discrete amounts to a recognized pet based on user-defined parameters. The dispenser comprises a plurality of receptacles, each capable of holding a sealed wet pet food container. Each container includes a code—such as a QR code, barcode, or RFID tag—located on a proximal portion, often on a backstay, which is readable via an integrated code reader.

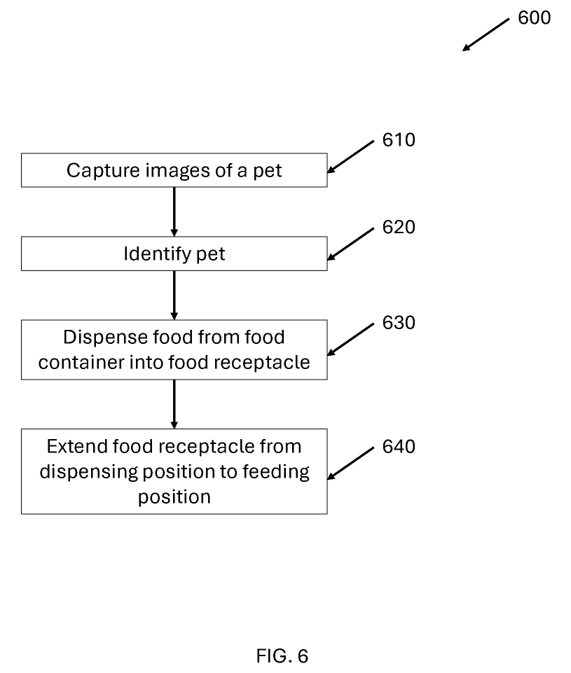

FIG. 6 depicts a method 600 for feeding a pet.

At block 610 one or more images of a pet are captured by the camera 150. Before a meal is dispensed, the system activates a camera that captures one or more images of a pet near the feeder.

At block 620 the captured images are processed by an onboard or remote processing system that uses facial recognition algorithms to identify the pet. If the pet is authorized to receive food, the processor proceeds with dispensing steps. The facial identification process may be trained in one or more, preferably at least six images of a pet’s face and/or body, each from a different position and/or orientation with respect to the pet.

At block 630 wet pet food from a container, such as container 112, may be dispensed into a food receptacle, such as a bowl. In some embodiments, a code reader, positioned to scan the backstay before any plunger engagement, captures the unique identifier, such as a code, associated with the container. The processor compares this code to a database of valid pet food container codes and in some embodiments, may cross-reference the container code with a dispenser ID and user computing system ID. If the container code is verified, the processor rotates the carousel to move the selected container into the dispensing position. All components—containers, dispensers, and user devices—may be associated with unique IDs. The processor verifies these IDs during code reading to ensure that only authorized containers are used with a given device and user account. The unique identification (ID) may be any suitable unique identifier as describe herein, such as machine readable code stored on a non-transitory medium, and may correspond to a number, such as a hexadecimal number or other suitable alphanumeric code, for example.

Each container rests in a receptacle of a carousel. Each receptable may include a platform with an opening that permits dispensed food to pass from the distal end of the container into a food receptacle. The food receptacle may be a bowl, pan, or tray, and is supported on a sliding tray mechanism.

The backstay includes a recess for plunger alignment and is sealed against the inner wall of the container with a gasket, which may be an O-ring or molded elastomeric component. The plunger, which is mounted on a linear actuator with encoder feedback, pushes the backstay toward the dispensing end, forcing food through a nozzle. The nozzle includes a hydrophobic or elastomeric valve (e.g., silicone slit such as plurality of slits, for example an X-slit or star shaped slit pattern) that opens under pressure and closes automatically when the force is removed.

In some embodiments, the processor controls displacement of the plunger in response to encoder feedback and from a load cell located beneath the food receptacle, achieving dispensing accuracy within one gram. In some embodiments, processor, plunger, and linear actuator are configured to dispense food with plunger motion resolution of 0.1 mm, or better, which corresponds to a dispensing accuracy of approximately within a range from about 300 mg to about 600 mg per 0.1 mm of displacement, depending on the diameter of the container, for example. In some embodiments, the local processor of dispenser 100 is configured to compare measured food dispensed with the load cell to an intended amount of dispensed food, for example while the wet pet food is being dispensed. In some embodiments, this comparison is used to detect feeding reliability, for example if the intended amount of wet pet food differs significantly (e.g. by at least 5%) from the amount measured, a potential fault may be detected with the wet pet food container or the dispenser, which can improve the reliability and safety of the automated feeding, for example while the pet owner is away.

The system can track the cumulative amount of food dispensed from a container, and if the container is exhausted, rotate a second container into position. In some embodiments, the processor is configured with instructions to divide the food dispensed for a single meal among a plurality of containers to reduce food waste.

In some embodiments, after food is dispensed, the processor in cooperation with load cell measures an amount of food dispensed into the feeing container before the tray is extended and measures an amount of food remaining feeding container when the tray has been retracted and determines an amount of food consumed at said each of plurality of pet feeding events. In some embodiments, a user interface, such as a user interface of user computing system 116 is configured to display an amount of food consumed during each pet feeding event.

In some embodiments, the amount of food consumed during each pet feeding event is used to monitor pet compliance with the diet. For example, if there is uneaten food after a meal, the user can decrease the amount of food administered at a pet feeding event. In some embodiments, the user interface is configured to allow the user to adjust an amount of dispensed wet pet food in response to pet compliance with the diet, for example to decrease an amount of dispensed wet pet food with a feeding event.

In some embodiments, after food is dispensed, a heating element may be activated to warm the meal. This heating element may be located below or in contact with the food receptacle, or integrated into the tray that extends from the dispenser body. Once the food reaches the desired temperature, the tray automatically extends to present the food to the pet.

An auditory stimulus (such as a chime or voice signal, e.g. the owners voice) may be emitted to notify the pet that feeding is available. After a period of time, or upon sensing that the food has been consumed—using the load cell or optional sensors like accelerometers or cameras—the tray retracts and the food consumption is logged.

At block 640 a tray, such as a drawer, supporting the food receptacle is extended from a position within the pet food dispenser 100 to a position external to the pet food dispenser 100.

The user interacts with the system via a computing interface, such as a smartphone app or desktop portal. The user interface allows users to select food types, adjust meal sizes, and review consumption data. It displays container usage status, showing how many unused and used containers are installed. For each feeding event, the amount of food dispensed and consumed is tracked and reported. The user may thereby control the operation of the system and aspects of the method 600 with the user interface on the user computing system 116.

Although FIG. 6 shows a method 600 of feeding a pet in accordance with some embodiments, one of ordinary skill in the art will recognize many adaptations and variations. For example, some of the steps can be repeated, some of the step can be omitted and the steps can be performed in any suitable order. Each of the steps may comprise a sub step or process of another step.

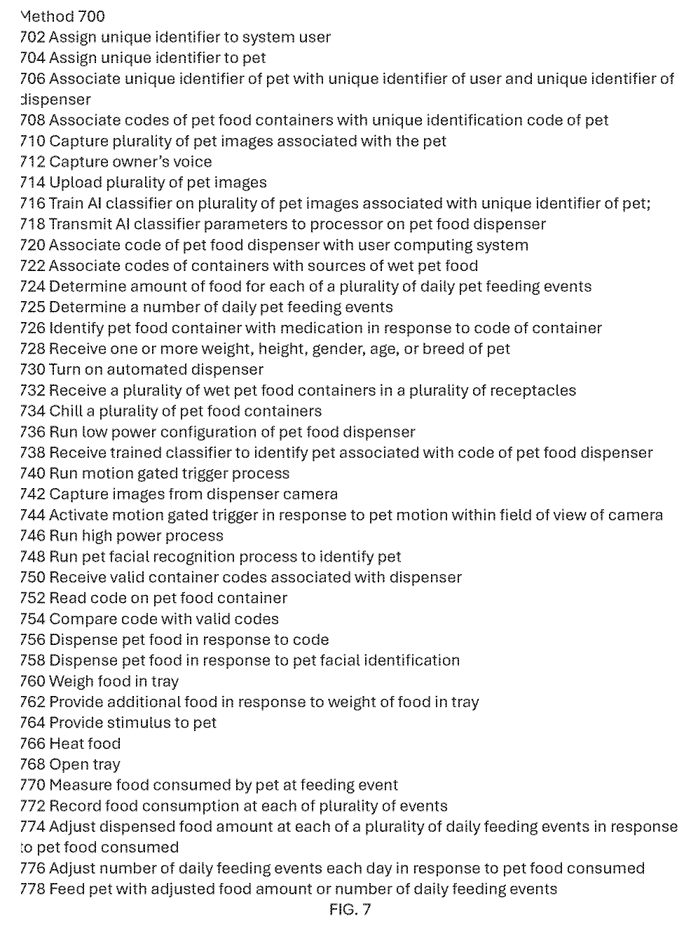

FIG. 7 shows a method 700 of feeding a pet a pet feeding system, in accordance with some embodiments.

At a step 702, unique identifier is assigned to system user, such as a login id.

At a 704, a unique identifier is assigned to a pet, which can be associated with a name of the pet.

At a step 706, the unique identifier of pet is associated with the unique identifier of the user and unique identifier of dispenser. In some embodiments, the unique identifier of the pet is associated with the unique identifier of each of a plurality of users, so that more than one person can feed the pet, for example when the owner is away. Alternatively or in combination, the unique identifier of the dispenser can be associated with the unique identifier of each of a plurality of users, so that a plurality of user computing systems can be used to access and control the dispenser and feeding as described herein.

In some embodiments, the unique identifiers and associations are stored in a database. Although reference is made to a database, in some embodiments the remote processing system may comprises one or more of a blockchain ledger or a distributed ledger, for example, which can be used to validate the users, for example.

At a step 708, codes of pet food containers are associated with one or more of the unique identification code of pet or ID code of the dispenser.

At a step 710, a plurality of pet images associated with the pet are captured, for example with the user computing device such as a smartphone.

At a step 712, the user, e.g. the owner’s voice is recorded. This can be down with the user computing system and uploaded to the pet food dispenser, for example.

At a step 714, upload plurality of pet images. In some embodiments, the pet images are uploaded to a remote server.

At a step 716, an AI classifier is trained on plurality of pet images associated with the unique identifier of the pet. In some embodiments, the AI classifier is trained on a remote server.

At a step 718, the trained AI classifier parameters are transmitted to the processor on the pet food dispenser. In some embodiments, the processor is located within a housing of the pet food dispenser.

At a step 720, a unique ID code of pet food dispenser is associated with user computing system, for example a smart phone.

At a step 722, codes of containers with of pet food containers are associated sources of wet pet food. This can be helpful for determining nutritional content of the wet pet food containers. In some embodiments, one or more of the wet pet food containers has a code associated with a medication. In some embodiments, the user interface is configured for the user to adjust an amount of wet pet food to adjust an amount of medication to a pet, e.g. dosing of the medication. In some embodiments, the processor is configured to dispense a portion of a meal from a wet pet food container, and a remaining portion of the from a different wet food container, in which one of the containers comprises the medication.

At a step 724, an amount of food for each of a plurality of daily pet feeding events is determined.

At a step 725, a number of daily pet feeding events are scheduled, for example at a times input by the user on the user computing system.

At a step 726, a pet food container associated with a medication is identified in response to code of container.

At a step 728, one or more weight, height, gender, age, or breed of pet is received by a processor, for example in response to a user input.

At a step 730, the automated dispenser is activated, for example by being turned on by a user.

At a step 732, a plurality of wet pet food containers are received in a plurality of receptacles, for example by being placed in the receptacles by the user.

At a step 734, a plurality of pet food containers are chilled, for example with the plurality of containers placed in the plurality of receptacles.

At a step 736, the pet food dispenser is run in a low power configuration, for example with decreased computational cycles.

At a step 738, trained classifier is received by the processor of the pet food dispenser to identify the pet. In some embodiments, the trained classifier is associated with one or more of the code of pet food dispenser or the code of the pet.

At a step 740, a motion gated trigger process runs while the dispenser is in the low power configuration.

At a step 742, images are captured from dispenser camera, for example with the low power configuration.

At a step 744, a motion gated trigger is activated in response to pet motion within field of view of camera, for example while the dispenser is in the low power mode.

At a step 746, high power process is run on the processor, for example for facial recognition.

At a step 748, a pet facial recognition process is run on the processor to identify pet, for example with increased power consumption from the processor.

At a step 750, valid container codes associated with dispenser are received by the dispenser.

At a step 752, a code on pet food container is read.

At a step 754, the code is compared with valid codes, for example valid codes stored on the processor of the dispenser.

At a step 756, pet food is dispensed in response to code.

At a step 758, pet food is dispensed in response to pet facial identification of the pet, for example with a trained classifier. In some embodiments, the wet pet food is dispensed in response to both a facial recognition of the pet and the valid code on the container. Although reference is made to facial recognition, embodiments of the present disclosure is well suited for use with other types of pet identification and food dispensing, such as RFID, in which an RFID chip is worn on a collar of the pet or implanted in the pet, for example.

At a step 760, food in the tray is weighed. In some embodiments, weight of the food receptacle is weighed prior to dispensing food to determine a tare weight.

At a step 762, provide additional food in response to weight of food in tray. In some embodiments, the processor is configured to dispense an amount of food, weigh the dispensed amount of food, and then provide an additional amount of food in response to the weight of the first amount, which can be helpful to decrease excessive food for a feeding event. In some embodiments, the processor is configured to run a closed loop process that uses the weight of dispensed food in the container to determine if additional food should be dispensed at a feeding event. Alternatively or in combination, encoders coupled to the plunger can be used to determine the distance the plunger has moved for a feeding event. In some embodiments, the displacement of the plunger is compared with the amount of wet food to detect a system fault, for example.

At a step 764, a stimulus is provided to the pet. The stimulus may comprise any suitable stimulus such as a sound, light or vibration. In some embodiments, the stimulus comprises the user’s voice. In some embodiments, the pet food dispenser comprises a speaker to emit the sound of the stimulus. Alternatively or in combination, the pet food dispenser may comprises a light source, such as a light emitting diode (LED) to provide the stimulus to the pet.

At a step 766, the dispensed wet pet food is heated in a tray.

At a step 768, the tray is extended and the feeding receptacle is exposed to the pet.

At a step 770, an amount of food consumed by pet at the feeding event is measured. In some embodiments a pet may not finish the meal because the pet is sick or has a gastrointestinal disorder. In some embodiments the user device receives a notification that a meal was not fully consumed (e.g. no more than 90 percent consumption). In some embodiments, the user can adjust the number of daily feeding events, for example increase the number of pet feeding events decrease an amount of food with each feeding event.

At a step 772, food consumption is recorded at each of plurality of pet feeding events

At a step 774, a dispensed food amount at each of a plurality of daily feeding events is adjusted in response to the amount of pet food consumed at each of the plurality of pet feeding events.

At a step 776, a number of daily feeding events is adjusted in response to pet food consumed, for example with a user input to the user computing system.

At a step 778, the pet is fed with the adjusted food amount or number of daily feeding events for each of the plurality of daily feeding events for a plurality of days.

In some embodiments, the user interface of the user device comprises an analytics dashboard to display meal data, such as a consumption data and amounts consumed with each meal of the plurality of meals dispensed each day. The user interface can be configured to display this data on each of plurality of user interfaces associated with a pet, for example. In some embodiments, the analytics dashboard is configured to display analytics data of meal consumption for a plurality of pets to each of a plurality of users, for example with pets in a kennel.

Although FIG. 7 shows a method 700 of feeding a pet in accordance with some embodiments, one of ordinary skill in the art will recognize many adaptations and variations. For example, some of the steps can be repeated, some of the step can be omitted and the steps can be performed in any suitable order. Each of the steps may comprise a sub step or process of another step.

Any step of any method can be combined with any step of any other method as described herein. For example, any step of method 600 can be combined with any step of method 700, for example.

### AI PET RECOGNITION

While the AI pet recognition algorithm can be configured in many ways, in some embodiments, the AI algorithm comprises a convolutional neural network (CNN). The AI pet recognition algorithm may comprise one or more of machine learning, supervised machine learning, unsupervised machine learning, neural networks, deep neural networks, convolutional neural networks, computer vision, Linear Regression. Logistic Regression, Decision Trees. , Random Forest, Support Vector Machines (SVM), K-Nearest Neighbors (KNN), as will be appreciated by one of ordinary skill in the art of artificial intelligence algorithms such as machine vision.

In some embodiments, the processor of the dispenser 100 is configured with a trained neural network classifier to identify the pet, such as a facial recognition algorithm. In some embodiments, the processor is configured with power management to decrease energy consumption, e.g. power consumption, and to more efficiently utilize system resources.

In some embodiments, the processor and camera comprise a Real-Time Multistage Pet Identification System with Motion-Gated Object Detection, Bag-of-Visual-Words Facial Classification, and Momentum-Based Confidence Smoothing. The processor is configured with a low power mode to detect the pet approaching the dispenser, in which the images from the camera are processed to detect pet movement toward the feeder, for example with a motion gated detector. In some embodiments, the motion gated detector is configured to activate a facial recognition routine, such a neural network, in response to movement of the pet within a field of view of the camera. In some embodiments, the trained CNN classifier comprises a Bag-of-Visual-Words (BoVW) facial classification classifier, in which the BoVW comprises extracted features from training images (e.g. uploaded by the pet owner), which are used to create a visual vocabulary (codebook), which represents the images as a histogram of visual word occurrences. In some embodiments, the momentum based confidence smoothing is used to improve the stability and accuracy of predictions, e.g. pet identification, for example in situations where model outputs may be noisy or fluctuate.

In some embodiments, the dispense comprises a computer vision system for identifying domestic animals in live video, and an embedded, low-power pipeline that combines motion analysis, neural object detection, feature-vector quantization, statistical classification, and temporal smoothing to recognize individual pets with high precision.

In some embodiments, the dispenser selectively activates computationally expensive neural computations only when motion is detected and smooths decisions across frames to suppress jitter, which decreases false positive identifications and false negative identifications of the pet.

### Motion Gated Trigger

In some embodiments, the automated pet food dispenser comprises a motion gated trigger. In some embodiments, a background-subtraction module, such as a Gaussian mixture model (GMM) with adaptive learning flags motion when any foreground contour area exceed a threshold amount. This motion gated trigger can be operated in the low power mode and requires less computational processing power than facial recognition, for example.

In response to the motion gated trigger being activated, the computationally expensive pet face object detector is activated. The approach can decrease power consumption of the processor by at least about 80%. In some embodiments, the decreased power consumption is helpful to maintain the cooled pet food at a suitable temperature as described herein, for example when the processor is located within the housing that also covers the wet pet food as described herein

### Pet Face/Object Detector

In some embodiments, the classifier to identify the pet comprises a neural network such as a convolutional neural network. In some embodiments, the classifier has been trained with images of the pet that have been uploaded by user to a remote server, and the trained classifier is downloaded to from the remote server to the processor on the dispenser, which can also help to maintain a cool temperature of the wet pet food. While the neural network may comprise any suitable neural network, in some embodiments the neural network comprises a commercially available neural network such as a you only look once neural network (YOLO) neural network, although other neural networks can be used such as multi-pass, e.g. two pass neural networks. In some embodiments, the neural network resident on the processor of the dispenser has been trained about 10,000 to about 50,000 annotated pet face tiles, e.g. with bounding-box labels, and outputs (x, y, w, h, confidence, class). In some embodiments, x and y refer to coordinates of a bounding box, and w and h refer to a width and height of the bounding box, for example.

In some embodiments, the images from the camera of the dispenser comprise a resolution of less than 1000 pixels by 500, e.g. 640×384 input.

In some embodiments CIOU (Complete IoU) is a loss function used for bounding box regression, BCE (Binary Cross Entropy) is used for classification and objectness, and BCE is also used for classification. CIOU measures the overlap and similarity between predicted and ground truth bounding boxes, while BCE quantifies the error in predicting class labels and the presence/absence of an object in a grid cell.

In some embodiments, the processor is configured to perform custom data augmentation, such as one or more of horizontal flip, photometric jitter, or furblur. In some embodiments furblur (random small-radius Gaussian to simulate motion). In some embodiments furblur comprises a technique for simulating motion blur, especially for fur, using a random Gaussian blur with a small radius.

### Compact Identity Classifier

In some embodiments, the neural network comprises a compact identity classifier suited for use on the processor of the dispenser. In some embodiments, the compact identity classifier comprises one or more of feature extraction, code-book generation, histogram, scaler or classifier.

In some embodiments, the feature extraction comprises SIFT or ORB data. In some embodiments, one or more of scale-invariant feature transform (SIFT) or Oriented FAST and Rotated BRIEF (ORB) are used for feature detection and description to find and characterize distinctive points in images. In some embodiments, ORB is faster and more computationally efficient than SIFT, making it a suitable choice for real-time applications like video processing or systems with limited processing power, such as on the processor within dispenser 100.

In some embodiments, Code-book generation comprises generating K centroids KMeans trained on any suitable number of descriptors, e.g. within a range from about 100,000 to about 1,000,000 descriptors, for example about 500,000 descriptors.

In some embodiments, a KMeans model with K=256 centroids on 500k descriptors is trained an resident on the processor of the dispenser. In some embodiments, this KMeans model is used in conjunction with local image descriptors like SIFT, for example, for tasks like image retrieval and classification.

Codebook/Visual Vocabulary: In some embodiments, the K=256 centroids, which are the result of the KMeans clustering, form the codebook or visual vocabulary, in which each centroid represents a "visual word" that is representative of a cluster of descriptors in the training data.

In some embodiments the 500k descriptors (e.g., SIFT, SURF, HOG) are the feature representations of images, which are extracted from the plurality of images uploaded from the user computing device and used to train the KMeans model, for example on the remote server.

In some embodiments, the K-means algorithm groups the descriptors into K clusters, with each cluster having a centroid that is the mean of the descriptors within that cluster.

In some embodiments, a histogram is used in which each descriptor votes 1 bin; L2-normalised to 1×K vector.

In some embodiments scaler is used, such as a StandardScaler(μ, σ) learned from training histograms, as will be understood by one or ordinary skill in the art of neural networks.

In some embodiments, a classifier is used. In some embodiments, the classifier comprises a linear SVM trained with one-vs-rest on N labelled pets and outputs probability of a match. In some embodiments, Support Vector Machines (SVMs) comprises supervised learning algorithms used for various tasks, including image classification and object detection, such as identifying the pet as described herein.

In some embodiments, a Temporal Momentum Filter is used, as will be understood by one of ordinary skill in the art of machine vision and convolutional neural networks.

In some embodiments, for each label ℓ: mℓ[t] = γ·mℓ[t-1] + pℓ[t], in which γ is a discount factor less than one, for example within a range from about 0.7 to about 0.95.

In some embodiments, the algorithm reports the label with max mℓ, and acts only when mmax crosses a threshold.

In some embodiments, the relationship mℓ[t] = γ·mℓ[t-1] + pℓ[t] represents a recursive relationship or a model within a system, possibly related to time-series data or a machine vision process. In some embodiments, mℓ[t]: represents the value of a variable mℓ at time t. It could be a state, a prediction, or a measurement in a system. In some embodiments, mℓ[t-1] is the value of mℓ at the previous time step (t-1). In some embodiments, this dependency on the past comprises a time-series model or a system where the current state is influenced by the previous state.

In some embodiments, γ is a constant factor, such as decay factor or damping factor. It determines how much weight is given to the previous state mℓ[t-1] when calculating the current state. In some embodiments, a value close to 1 indicates a strong reliance on the previous state, while a value close to 0 indicates that the previous state has little influence.

In some embodiments, pℓ[t] represents an external input or noise term at time t. It could be a signal, a disturbance, or an unknown factor that affects the system’s state.

Processors and cameras capable of implementing the pet identification will be known to one of ordinary skill in the art of machine vision, and may comprises commercially available processors and cameras.

### Energy Management

In some embodiments, the processor is configurated to implement a low power mode with an idle power draw of no more than about 2 Watts. In some embodiments this is because the CNN layers are skipped when no motion is detected. In some embodiments, the processor is configured to implement a high power mode, for example with a peak power draw within a range from 3 to 4 Watts, for example with a duty cycle of no more than about 20%, e.g. 15%.

In some embodiments, the CNN comprises a two-tier hybrid architecture that fuses a small-footprint CNN for generic localization with a Bag-of-Words identity classifier, allowing rapid enrolment of new pets without retraining the detector.

In some embodiments the motion gated compute scheduler lowers average (Floating-Point Operations Per Second) FLOPS.

In some embodiments a momentum filter with exponential decay yields temporal stability while maintaining responsiveness – avoids majority-vote latency of sliding windows.

In some embodiments, an LED and General Purpose Input output (GPIO) actuation pipeline is integrated into the algorithmic flow of the processors, enabling native control of external mechanisms (doors, feeders) in real time.

Adaptive data-augmentation strategy such as furblur as described herein improves generalization to blurry fur textures common in close-range pet images.

While the processor can be configured in many ways to identify a pet, in some embodiments, the processor is configured to:
receive successive video frames from the camera;
performing background subtraction on each frame and, responsive to determining that the frame lacks motion above a threshold, skipping subsequent steps for that frame; on a frame containing motion, executing a convolutional neural network to detect at least one bounding box encompassing an animal face such as a pet; for each bounding box, extracting local visual descriptors, mapping the descriptors to a code-book to generate a fixed-length histogram, and classifying the histogram with a linear support-vector machine to obtain a probability that the animal is the pet.

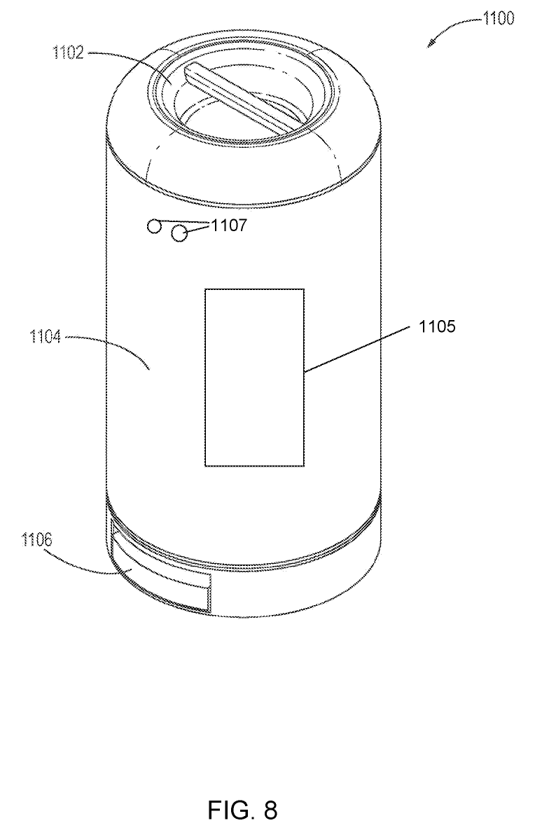

FIG. 8 is a schematic diagram depicting embodiments of an automated pet food dispenser 1100. As depicted, automated pet food dispenser 1100 includes upper structure 1102, outer housing 1104, and drawer 1106.

In some embodiments, the outer housing 1104 comprises a door 1105 to allow access to an interior of the pet food dispense 1100, for example to replace pet food containers as described herein. The door 1105 can be configured in many ways, and may comprise a hinges, or one or more sliders, to open the door 1105. In some embodiments, the door is configured to be opened and closed while the housing remains in place and covers an interior of the pet food dispense 1100. In some embodiments, the door is configured to be removed with the housing 1104 when the housing is removed, for example.

In some embodiments, the housing 1104 comprises one or more ports 1107 to allow the pet to be illuminated, viewed and imaged with a camera, for example with infrared illumination and an infrared camera as described herein. In some embodiments, the camera is configured to view a face for facial recognition and identification of the pet. The one or more ports 1107 can be configured in many ways, for example with an aperture through the housing 1104 or a portion of the housing 1104 that comprises a transparent material, such as an infrared transmissive transparent material and combinations thereof.

In some embodiments, upper structure 1102 may be designed to function as a carrying handle. A user may transport automated pet food dispenser 1100 using upper structure 1102 as a carrying handle. Upper structure 1102 may also include one or more LED lamps that may function as status indicators for automated pet food dispenser 1100. For example, the LED lamps may indicate if automated pet food dispenser 1100 has run out of food.

In some embodiments, outer housing 1104 may serve as a protective covering for one or more internal elements of automated pet food dispenser 1100. In one embodiment, outer housing 1104 is constructed of a plurality of connected pieces. In another embodiment, outer housing 1104 is constructed as a single, solid structure. Outer housing may also serve to provide cosmetic or aesthetic appeal to automated pet food dispenser 1100.

Drawer 1106 may be configured to be a retractable drawer that can be used to support and store a food bowl such as food bowl 114 or 218. Under normal storage, when no pet feeding is occurring, drawer 1106 may be retracted to be substantially flush with an outer surface of outer housing 1104. In this position, the food bowl is concealed within automated pet food dispenser 1100. During a feeding session, automated pet food dispenser may fill the food bowl with the requisite quantity of food. Drawer 1106 may then be extended outwards by a processing system (e.g., processing system 102) to reveal the food bowl to the pet. After the pet consumes the food or after a specified amount of time, automated pet food dispenser 1100 (specifically, the processing system included in automated pet food dispenser 1100) may retract drawer 1106.

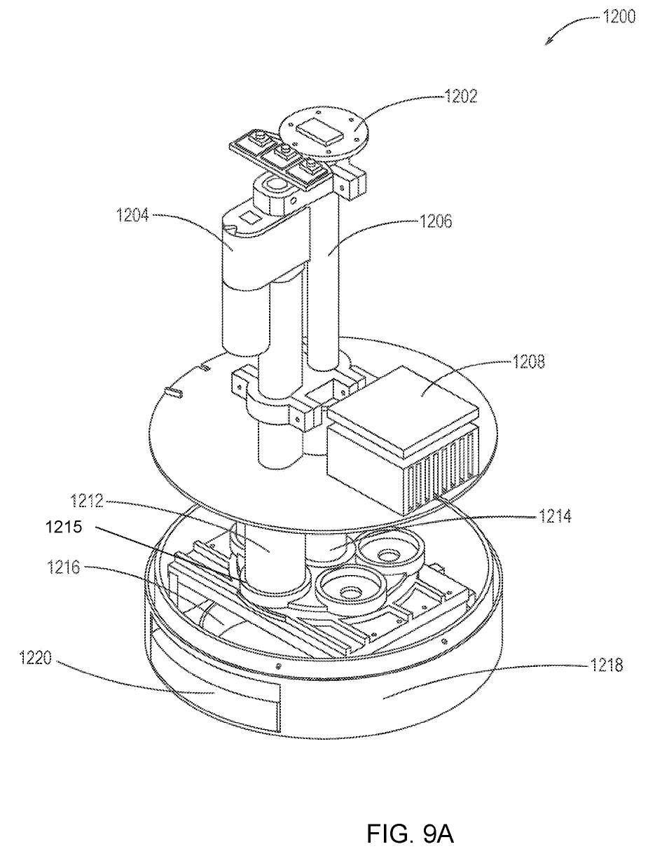

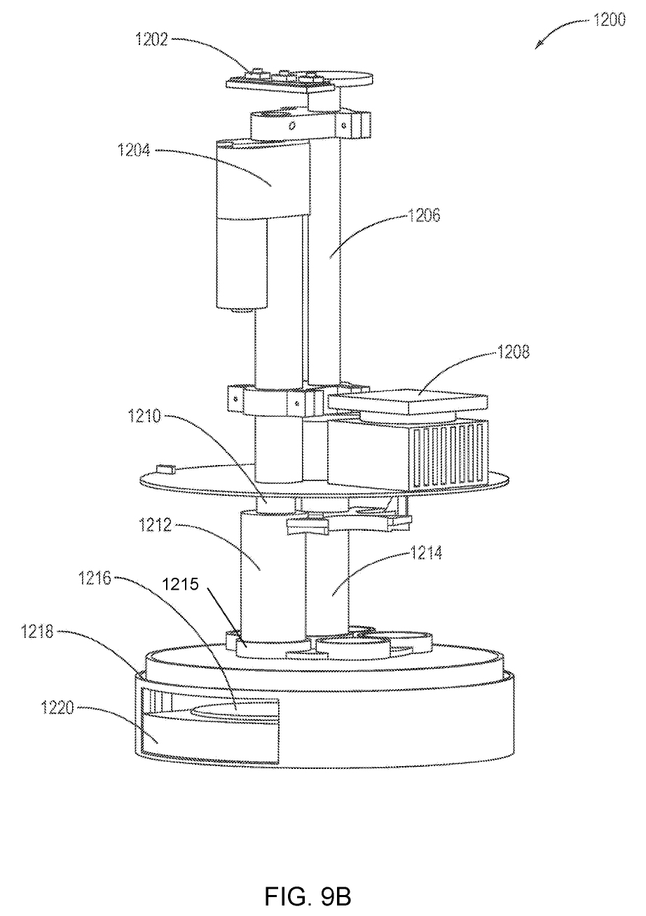

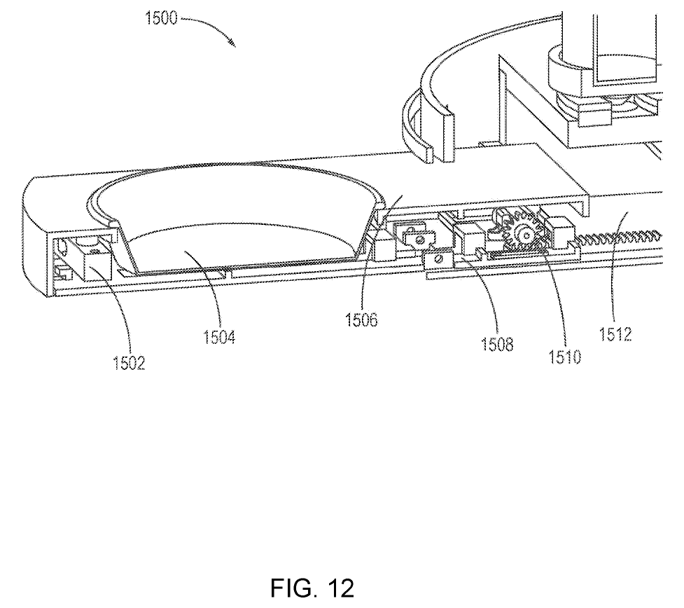

FIGS. 9A and 9B are schematic diagrams depicting an internal structure 1200 of an automated pet food dispenser, in accordance with some embodiments. FIG. 9A depicts an isometric view of internal structure 1200, while FIG. 9B depicts a side view of internal structure 1200. Internal structure 1200 may be associated with an internal structure of automated pet food dispenser 1100 that may be revealed if outer housing 1104 is removed from automated pet food dispenser 1100. As depicted, internal structure 1200 includes user interface 1202, linear actuator 1204, support structure 1206, cooling unit 1208, plunger 1210, food container 1212, receptacle 1213 to receive container 1212, carousel 1214, food bowl 1216, base 1218, and drawer 1220. Internal structure 1200 may also include a processing system such as processing system 102 (not depicted in FIGS. 12A and 12B).

In some embodiments, user interface 1202. User interface 1202 may be configured to allow a user (e.g., a pet owner) to interact with automated food dispenser 1100. User interface 1202 may include any combination of input/output devices such as push buttons, video display screens, LCD screens, touch screens, switches, incandescent bulbs, LED bulbs, haptic feedback devices, and so on. The user interface 1202 may comprise one or more components of the computing system 116, such as a touch screen display, for example. In some embodiments, a user programs data such as a feeding schedule (e.g., a feeding time or a feeding time interval), and a quantity of wet pet food to be dispensed, via user interface 1202, which may comprise a touch screen display of the computing system as described herein. In some embodiments, user input/output components associated with user interface 1202 may be integrated onto a printed circuit board (PCB). User interface 1202 may be configured to drive the one or more LEDs associated with upper structure 1102.

Linear actuator 1204 may be similar to actuator 104. Linear actuator 1204 may receive one or more instructions or commands from a processing system such as processing system 102 to extend or retract plunger 1210. Linear actuator 1204 comprise any of a lead screw linear actuator, a pneumatic actuator, a hydraulic actuator, or a rigid chain-based actuator. The linear actuator may comprise one or more encoders to provide feed back corresponding to the displacement of the linear actuator to accurately dispense food as described herein. The encoder may comprise any suitable encoder, such as a rotational encoder mounted on the motor, or along a movable component of the linear actuator, for example. In some embodiments, the encoder measures displacement of the plunger.

Support structure 1206 may be similar to support 108. Support structure 1206 may provide a substantially rigid support to one or more internal components of automated pet food dispenser such user interface 1202, linear actuator 1204, cooling unit 1208, plunger 1210, container 1212, receptacle 1213, and carousel 1214.

In some embodiments, cooling unit 1208 provides cooling or refrigeration functions to keep wet pet food in a pet food container (e.g., pet food container 112) within a receptacle 1213 at a lower temperature than an ambient temperature. Cooling unit 1208 may also be referred to as a “refrigeration unit.” Maintaining the wet pet food at a lower temperature than the ambient temperature helps increase food shelf life, reduce bacterial growth rates, and keep the wet pet food fresh for a longer period of time.

In some embodiments, cooling unit 1208 may be any combination of thermoelectric cooler, a heatsink, and a fan. The thermoelectric cooler may help reduce a temperature of the wet pet food to a temperature below the ambient temperature. The heatsink may be used to dissipate any heat generated by components such as cooling unit 1208, linear actuator 1204, or processing system 102. The fan may be used to circulate air within automated pet food dispenser 1100 to maintain a substantially constant temperature within automated pet food dispenser 1100 or within a portion of automated pet food dispenser 1100.

In some embodiments, processing system 102 monitors a temperature of the wet pet food in a pet food container such as pet food container 112, and controls cooling unit 1208 via a feedback control loop to maintain the wet pet food at a substantially constant temperature. Such a feedback control loop may be configured such that cooling unit 1208 is switched on or off based on commands from processing system 102. This, in turn, can allow automated pet food dispenser 1100 to account for daily and seasonal temperature fluctuations in the ambient temperature while maintaining the temperature of the wet pet food in pet food container 112 at a substantially constant value.

In some embodiments, a pet food container 1212 similar to pet food container 112 may be inserted or placed into receptacle 1211. In some embodiments, wet pet food container 1212 may be referred to as a food cannister, for example a round cylindrical container as described herein. At a designated pet feeding time, processing system 102 may command linear actuator 1204 to extend plunger 1210 into container 1212. Plunger 1210 may exert a force on the pet food container within receptacle 1213. In some embodiments, motion of the pet food container within receptacle is constrained by an insert. The insert may prevent motion of the pet food container while linear actuator 1204 applies a force to the pet food container via plunger 1210. In some embodiments, receptacle 1212 is constructed to have a built-in physical restraint that prevents motion of the pet food container while linear actuator 1204 applies a force to the pet food container via plunger 1210. In some embodiments, the force exerted by plunger 1210 may cause the pet food container to rupture, and the contents of the pet food container may be dispensed into food bowl 1216 through an opening at the bottom of receptacle 1213.

In some embodiments, piston 1210 is similar to plunger 106. Piston 1210 may be configured to be substantially coaxial with the pet food container 1212 when placed in the receptacle 1213, so that piston 1210 is contained within the container 1212 when piston 1210 is extended by linear actuator 1204.

In some embodiments, a quantity of pet food dispensed may be measured by a load cell (not depicted in internal structure 1200). Measurements from the load cell may be received by processing system 102. Processing system 102 may command linear actuator 1204 to stop extending plunger 1210 when a quantity of food in food bowl 1216 as measured by the load cell is greater than or equal to a predetermined amount. Processing system 102 may also retract plunger 1210.

Once a requisite quantity of pet food is dispensed into food bowl 1216, processing system may command an electrical motor to extend drawer 1220 and reveal food bowl 1216 to a pet. This initiates a feeding routine. Drawer 1220 may be similar to drawer 1106. Drawer 1120 may be alternatively referred to as a “tray.” In some embodiments, the electrical motor actuates the extension of drawer 1220 along a linear path, using a rack-and-pinion mechanism.

Processing system 102 may be configured to keep track of time elapsed since drawer 1220 is extended. Processing system 102 may also be configured to keep track of a weight of wet pet food remaining in food bowl 1216 based on one or more weight measurements from the load cell. If the time elapsed is greater than or equal to a predetermined time limit or the weight of wet pet food remaining in food bowl 1216 is significantly less than the dispensed quantity (suggesting that all or most of the wet pet food has been consumed), then processing system 102 may retract drawer 1220 back into base 1218. Base 1218 may provide a concealing enclosure for food bowl 1216, as well as a bottom support for internal elements of automated pet food dispenser 1100.

In some embodiments, drawer 1220 may include one or more accelerometers and/or gyroscopes to measure vibration motion of drawer 1220 and food bowl 1216. These vibration measurements may be transmitted to processing system 102. Excessive vibrations may suggest that a pet is currently in a vicinity of automated pet food dispenser 1100, and might be currently feeding. Processing system 102 may make a decision to keep drawer 1220 extended while vibration measurements are at relatively higher levels. A substantial reduction in vibration levels may suggest that the pet has finished feeding and has left a vicinity of automated pet food dispenser 1100. Processing system 102 may command drawer 1220 to retract responsive to this reduction.

In some embodiments, processing system 102 is configured to determine how rapidly food is being consumed from food bowl 1216. This functionality may be accomplished by computing a rate of food consumption as a function of time, where load cell readings associated with the weight of the wet pet food in food bowl 1216 are sampled at discrete time intervals.

In some embodiments, carousel 1214 is configured to hold a plurality of wet pet food containers, such as receptacle 1212. For example, carousel 1214 may hold six wet pet food containers. Carousel 1214 may also be configured to rotate about an axis of rotation that may be substantially parallel to an axis associated with linear actuator 1214 and plunger 1210. A user may fill each of the plurality of receptacles held by carousel 1214 with an individual pet food container that may be similar to pet food container 112.

In some embodiments, carousel 1214 is initially positioned such that a first wet pet food container placed in a first receptacle is substantially coaxial with plunger 1210. Processing system 102 may initiate a pet feeding routine from a pet food container contained in this first receptacle. Processing system 102 may be configured to determine how much food remains in the pet food container based on how much plunger 1210 is extended. When plunger 1210 is extended to a certain length (e.g., 6 inches), processing system 102 may determine that a bottom of plunger 1210 may be close to a bottom end of the first receptacle. This, in turn, indicates that the amount of wet pet food within the container placed in the first receptacle is substantially empty. Responsive to this determination, processing system 102 may retract plunger 1210 so that plunger 1210 is completely outside of the first container. Processing system 102 may then command an electrical motor connected to carousel 1214 to rotate carousel 1214 about the axis of rotation so that a second container filled with a pet food placed in a second receptacle is substantially coaxial with plunger 1210. A subsequent feeding routine is then initiated from the second container placed in the second receptacle, until the pet food contained in the second container placed in the second receptacle is substantially empty. The second container is then replaced by a third container by rotating carousel 1214, and so on, until the pet food containers in all receptacles have been used. Processing system 102 may then issue one or more alerts to a user via user interface 1202, or to computing system 116 via wireless communication link 120.

Carousel 1214 allows extended periods of a plurality of unattended pet feeding sessions via the plurality of containers placed in receptacles. Carousel 1214 may be especially beneficial if a pet owner has to be out of the home for extended periods of time (e.g., a vacation).

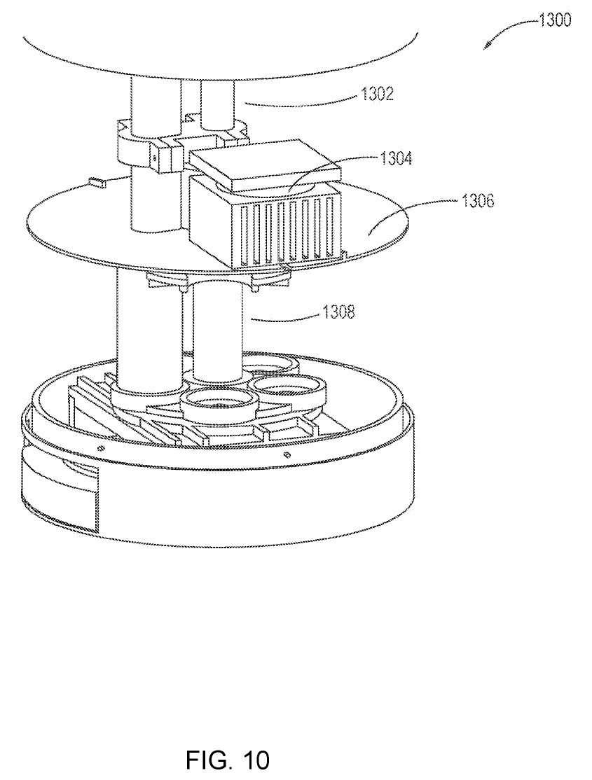

FIG. 10 is a schematic diagram depicting an internal structure 1300 of embodiments of automated pet food dispenser 1100. As depicted, internal structure 1300 includes hot side plenum 1302, cooling unit 1304, thermal bulkhead 1306, and cold side plenum 1308.

In some embodiments, cooling unit 1304 is similar to cooling unit 1208. Thermal bulkhead 1306 may be configured to thermally isolate hot side plenum 1302 from cold side plenum 1308. Hot side plenum 1302 may be a portion of an internal structure of automated pet food dispenser 1100 that is at a higher temperature relative to cold side plenum 1308. Hot side plenum may include linear actuator 1204, processing system 102, user interface 1202, cooling unit 1208, and other components that may generate heat during operation. Thermal bulkhead 1306 may function to thermally isolate cold side plenum 1308 from the heat generated by these heat-generating components.

In some embodiments, cold-side plenum 1308 is cooled by cooling unit 1304 to be at a temperature that is lower than an ambient temperature. Cold-side plenum 1308 may include components such as carousel 1214, and container 1212 placed in receptacle 1213. Cold-side plenum 1308 may include a space around the plurality of receptacles associated with carousel 1214, whose temperatures are being controlled. Some embodiments include one or more insulating features, e.g., insulation in outer housing 1104 or base 1218 to help regulate heat flow. Thermal bulkhead 1306 reduces an amount of heat transferred from hot side plenum 1302 to cold side plenum 1308. This further helps maintain a temperature of one or more pet food containers stored in cold side plenum 1308 at a temperature below an ambient temperature. This further helps in maintaining pet food freshness, while reducing bacterial growth rates.

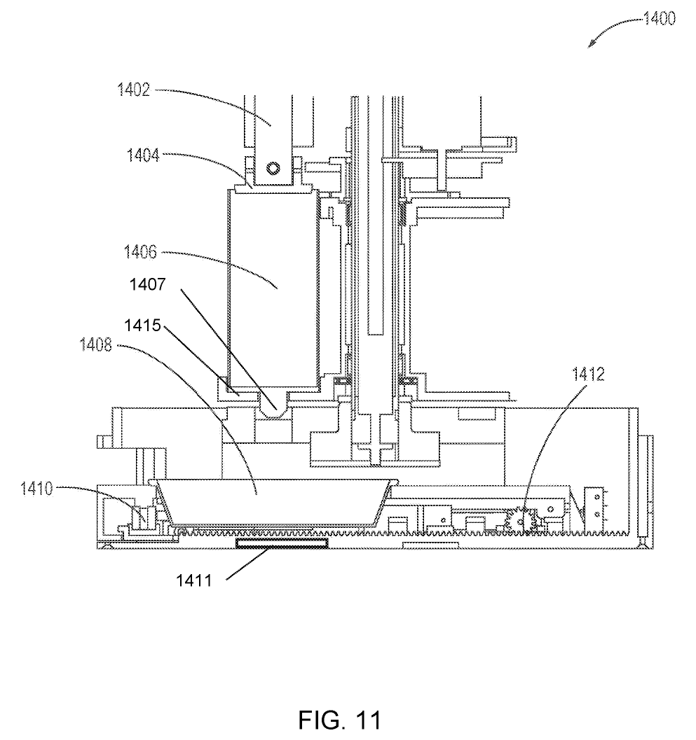

FIG. 11 is a schematic diagram depicting a cross-sectional view 1400 of a portion of automated pet food dispenser 1100. As depicted, cross-sectional view includes linear actuator 1402, plunger 1404, wet pet food container 1406, food bowl 1408, load cell 1410, heating element 1411 and rack-and-pinion mechanism 1412.

In some embodiments, heating element 1411 is coupled to the processing system and configured to heat chilled food dispensed from container 1406. While the heating element 1411 can be configured in many ways, in some embodiments the heating element remain stationary when the drawer is extended and retracted. Alternatively, the heating element 1411 can be coupled to the drawer to move with the drawer, for example.

Linear actuator may be similar to linear actuator 1204, plunger 1404 may be similar to plunger 1210, container 1406 may be similar to container 1212, food bowl 1408 may be similar to food bowl 1216, and load cell 1410 may be similar to load cell 118.

Cross-sectional view 1406 depicts how linear actuator 1402, plunger 1404, and wet pet food container 1406 are substantially coaxial. Cross-sectional view 1406 also depicts how plunger 1404 is designed to be contained within wet pet food container 1406.

In some embodiments, the wet pet food container 1406 comprises a nozzle 1407 to deliver wet pet food through an opening in receptacle 1415.

In some embodiments, processing system 102 is configured to extend or retract drawer 1220 via an electrical motor that actuates rack-and-pinion mechanism 1412. This extension or retraction may be associated with one or more pet feeding events. Load cell 1410 may be configured to measure a weight of dispensed wet pet food in food bowl 1408.

FIG. 12 is a schematic diagram depicting a cross-sectional view of a bowl tray assembly 1500. As depicted, bowl tray assembly 1500 includes load cell 1502, food bowl 1504, upper section 1506, lower section 1508, electrical motor 1510, and base 1512.

Load cell 1502 may be similar to load cell 1410, and food bowl 1504 may be similar to food bowl 1408. Upper section 1506 and lower section 1508 may be configured to collectively enclose internal components such as load cell 1502 and electrical motor 1510 while forming an external structure for drawer 1220. Electrical motor 1510 may be configured to drive rack-and-pinion mechanism 1412 under command of processing system 102. Base 1512 may be similar to base 1218.

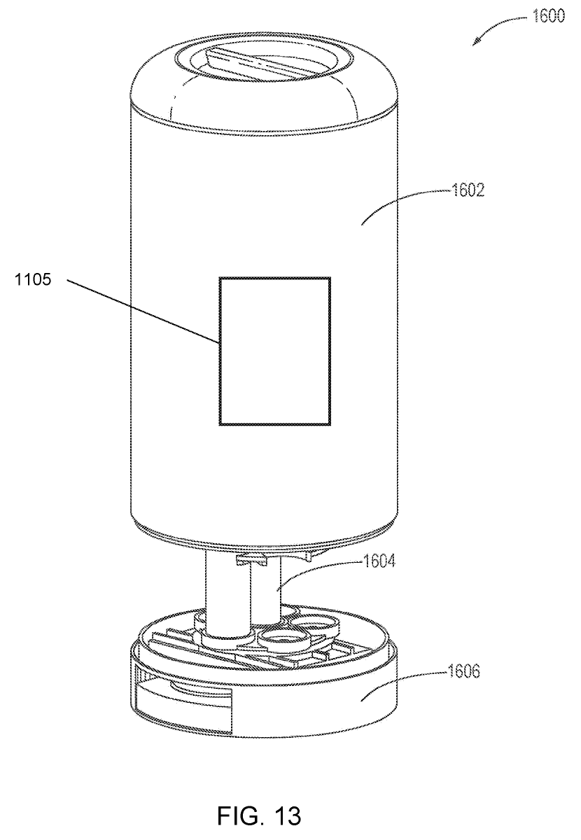

FIG. 13 is a schematic diagram depicting a view 1600 of automated pet food dispenser 1100. As depicted, view 1600 shows automated pet food dispenser 1100 in a partially disassembled state. As depicted view 1600 includes outer housing 1602, support structure 1604 and base 1606. Outer housing may be similar to outer housing 1104, support structure 1604 may be similar to support structure 1206, and base 1606 may be similar to base 1218. In some embodiments, outer housing 1602 may be removed from automated pet food dispenser 1100 along a vertical direction. Such a removal allows a user access to internal components of automated pet food dispenser 1100. For example, a user may remove outer cover 1100 to remove empty pet food containers and/or refill one or more receptacles with new pet food containers. A service technician may remove outer cover 1100 to service or repair one or more components of automated pet food dispenser 1100. For example, the service technician may plug in a diagnostic tool into processing system 102 to run fault detection and other diagnostic procedures.

In some embodiments, outer housing 1602 comprises a door 1105, as described herein.

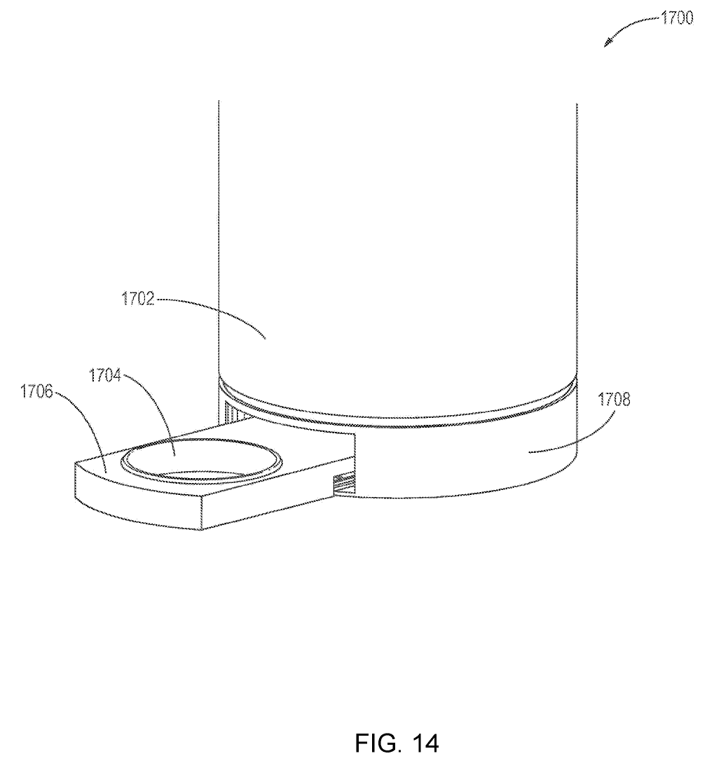

FIG. 14 is a schematic diagram depicting a portion 1700 of automated pet food dispenser 1100. As depicted, portion 1700 includes outer cover 1702, food bowl 1704, drawer 1706, and base 1708. Outer cover 1702 may be similar to outer cover 1104, food bowl 1704 may be similar to food bowl 1216, drawer 1706 may be similar to drawer 1220, and base 1708 may be similar to base 1218.

Drawer 1706 is depicted to be in an extended state. This extension may be initiated by processing system 102 during a feeding event. Processing system 102 may also extend drawer 1706 based on a user command. For example, a user may instruct processing system to extend drawer 1706 so that the user may remove food bowl 1704 for cleaning. This extension may be accomplished via rack-and-pinion mechanism 1412 and electrical motor 1510 via command from processing system 102.

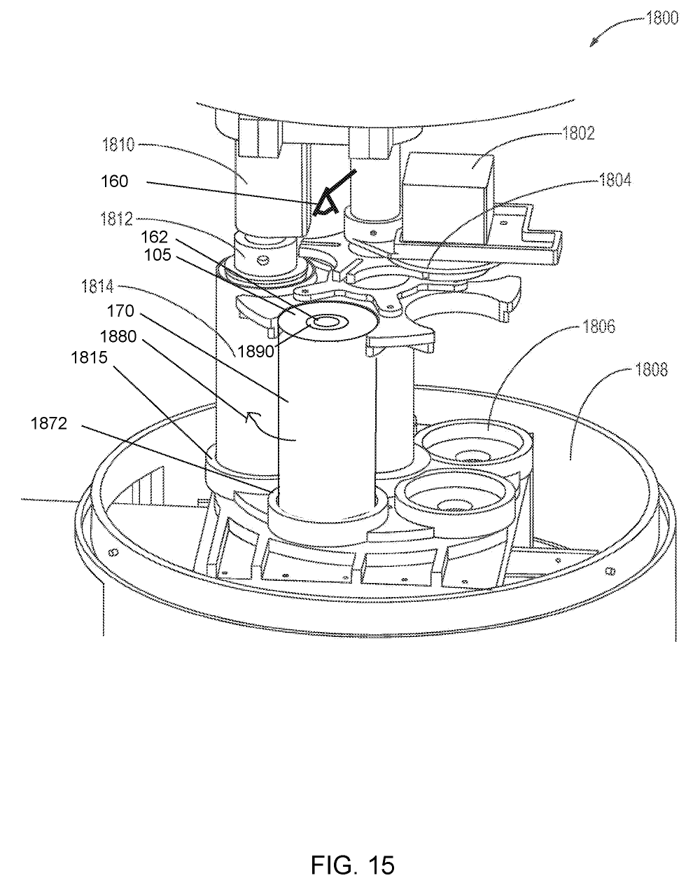

FIG. 15 is a schematic diagram depicting an internal structure 1800 of automated pet food dispenser 1100. As depicted, internal structure 1800 includes electrical motor 1802, rotating element 1804, carousel 1806, base 1808, linear actuator 1810, plunger 1812, wet pet food container 1814 placed in receptacle 1815, second wet food container 170 placed second receptacle 1872, code reader 160, code 162, backstay 105 and beveled region 1890 of backstay 105.

In some embodiments, code reader 160 is configured to read code 162 at a location of the container that is not visible to the code reader when the container is dispensing food. This approach can allow for more efficient utilization of the interior of the automated pet food dispenser and decrease its overall size. In some embodiments, wet pet food container 1814 comprises a first wet pet food container and wet pet food container 170 comprises a second wet pet food container. In some embodiments, code 162 is located on backstay 105 at a location that is engaged by the plunger. The code 162 on the second container is read while the first wet pet food container is positioned to dispense wet pet food. Once container 1814 has dispensed wet pet food, container 170 is rotated into position to dispense wet pet food as indicated by arrow 1880.

In some embodiments, carousel 1806 is similar to carousel 1214, base 1808 is similar to base 1218, linear actuator 1810 is similar to linear actuator 1204, plunger 1812 is similar to plunger 1210, receptacle 1815 is similar to receptacle 1215, and container 1814 is similar to container 1212.

In some embodiments, electrical motor 1802 is commanded by processing system 102 to rotate carousel 1806. Such a rotation command may be initiated by processing system 102 to switch between a receptacle containing a substantially empty pet food container to a receptacle containing a new pet food container. In some embodiments, electrical motor 1802 may rotate carousel 1806 using rotating element 1804. In some embodiments, rotating element 1804 is a Geneva wheel or a Geneva drive. Receptacle 1814 and other receptacles associated with carousel 1806 may be removable by a user for cleaning or replacement.

Embodiments of automated pet food dispenser such as automated pet food dispenser 100, automated pet food dispenser 200, and automated pet food dispenser 1100 may include any combination of the following features:

The communication link between processing system 102 computing system 116 may also include a wired communication link such as USB, Ethernet, UART, or some other wired communication interface.

Embodiments of automated pet food dispensers described herein may be powered by any combination of electrical power sourced from an electrical outlet or electrical power sourced from one or more batteries.

Embodiments of automated pet food dispensers described herein may include communications security and a programmable ID so that a particular dispenser can be selected using computing system 116 via wireless communication link 120. This is beneficial for scenarios such multi-unit applications like pet hotels, animal hospitals, common carriers transporting multiple pets at a time, and so on.

In some embodiments, a user can fill pet food containers containing different kinds of wet pet food in different receptacles when initializing carousel 1214. The user can then program processing system 102 (for example, via computing system 116 or via user interface 202) to dispense a specific kind of food at a specific feeding time in the feeding schedule.

Some embodiments may include a user logging in to an application software running on computing system 116. This application software may allow the user keep track of when a pet food container has been put in, its expiration date, and other parameters. The application software may warn the user when an expiration date associated with a pet food container is getting near.

Parameters associated with scheduling feeding times and feeding amounts may include any combination of ambient temperature, previous patterns of consumption, detecting a pet’s presence, an abundance or a scarcity of remaining food in the carousel, and so on.

As described herein, the computing devices and systems described and/or illustrated herein broadly represent any type or form of computing device or system capable of executing computer-readable instructions, such as those contained within the modules described herein. In their most basic configuration, these computing device(s) may each comprise at least one memory device and at least one physical processor.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or embodiments combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which includes one or more executable instructions for implementing the specified logical function(s). It is also noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

The term “memory” or “memory device,” as used herein, generally represents any type or form of volatile or non-volatile storage device or medium capable of storing data and/or computer-readable instructions. In one example, a memory device may store, load, and/or maintain one or more of the modules described herein. Examples of memory devices comprise, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “processor” or “physical processor,” as used herein, generally refers to any type or form of hardware-implemented processing unit capable of interpreting and/or executing computer-readable instructions. In one example, a physical processor may access and/or modify one or more modules stored in the above-described memory device. Examples of physical processors comprise, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor. The processor may comprise a distributed processor system, e.g. running parallel processors, or a remote processor such as a server, and combinations thereof.

Although illustrated as separate elements, the method steps described and/or illustrated herein may represent portions of a single application. In addition, in some embodiments one or more of these steps may represent or correspond to one or more software applications or programs that, when executed by a computing device, may cause the computing device to perform one or more tasks, such as the method step.

In addition, one or more of the devices described herein may transform data, physical devices, and/or representations of physical devices from one form to another. Additionally or alternatively, one or more of the modules recited herein may transform a processor, volatile memory, non-volatile memory, and/or any other portion of a physical computing device from one form of computing device to another form of computing device by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media comprise, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

The processor as described herein can be configured to perform one or more steps of any method disclosed herein. Alternatively or in combination, the processor can be configured to combine one or more steps of one or more methods as disclosed herein.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and shall have the same meaning as the word “comprising.

The processor as disclosed herein can be configured with instructions to perform any one or more steps of any method as disclosed herein.

It will be understood that although the terms “first,” “second,” “third”, etc. may be used herein to describe various layers, elements, components, regions or sections without referring to any particular order or sequence of events. These terms are merely used to distinguish one layer, element, component, region or section from another layer, element, component, region or section. A first layer, element, component, region or section as described herein could be referred to as a second layer, element, component, region or section without departing from the teachings of the present disclosure.

As used herein, the terms “a processor” or “the processor” encompass one or more processors.

As used herein, a “processor” encompasses any device that processes an analog or digital signal or data. In some embodiments, a processor encompasses a central processing unit (CPU) and memory. As used herein “a processor” encompasses one or more processors.

As used herein, the term “or” is used inclusively to refer items in the alternative and in combination.

As used herein, characters such as numerals refer to like elements.

The present disclosure includes the following numbered clauses.

Clause 1. An automated wet pet food dispenser to feed a pet, comprising: a plurality of receptacles to receive a plurality of wet pet food containers; a plunger to engage a wet pet food container among the plurality of wet pet food containers; a camera to capture one or more images of the pet; a processor operatively coupled to the camera, the code reader and the plunger, the processor configured with instructions to: receive the one or more images; identify the pet in response to the one or more images; dispense wet pet food from the container among the plurality of containers onto a food receptacle with the plunger; and extend a tray supporting the food receptacle to feed the pet in response to identification of the pet.

Clause 2. The dispenser of clause 1, further comprising a code reader operatively coupled to the processor to read a code on the wet pet food container.

Clause 3. The dispenser of any preceding clause, wherein the processor is configured to read the code on the wet pet food container before the plunger engages the wet pet food container.

Clause 4. The dispenser of any preceding clause, wherein the code reader is configured to read the code on a proximal portion of the wet pet food container.

Clause 5. The dispenser of any preceding clause, wherein the code reader is configured to read the code on a backstay of the wet pet food container.

Clause 6. The dispenser of any preceding clause, wherein the plunger is configured to at least partially cover the code on the backstay of the container and the code reader is configured to read the code on the container prior to the plunger engaging the backstay.

Clause 7. The dispenser of any preceding clause, wherein the code reader is configured to read the code on the pet food container prior to the pet food container being placed in a dispensing location.

Clause 8. The dispenser of any preceding clause, wherein the processor is configured to rotate the wet pet food container on a carousel to the dispensing location.

Clause 9. The dispenser of any preceding clause, wherein the plurality of pet food containers comprises a plurality of codes and wherein the processor is configured to read each of the plurality of codes prior to dispensing food from each of the plurality of containers.

Clause 10. The dispenser of any preceding clause, wherein the processor is configured to move a container at the dispensing location away from the dispensing location to read the code on the container and to move the container back to the dispensing location to dispense the food.

Clause 11. The dispenser of any preceding clause, wherein the processor is configured to compare the code on the container with a database of valid pet food container codes.

Clause 12. The dispenser of any preceding clause, wherein the processor is configured to identify the code as a valid code for use with the pet food dispenser.

Clause 13. The dispenser of any preceding clause, the processor is configured to is configured to dispense the wet pet food from the food container onto the feeing container in response to the valid code

Clause 14. The dispenser of any preceding clause, wherein the dispenser comprises a code to identify the dispenser and wherein the processor is configured to compare the dispenser code with the code on the food container to identify the code on the food container as a valid code.

Clause 15. The dispenser of any preceding clause, wherein the code reader comprises an illuminator to illuminate the code on the container.

Clause 16. The dispenser of any preceding clause, wherein the one or more images, wherein the one or more images comprises a plurality of images captured from the camera.

Clause 17. The dispenser of any preceding clause, wherein the processor is configured to identify the pet with a facial recognition routine in response to the one or more images from the camera.

Clause 18. The dispenser of any preceding clause, wherein the facial recognition routine comprises a convolutional neural network (CNN) classifier and wherein the classifier has been trained with a plurality of images from a camera of user computing device and the CNN classifier is configured to identify the pet in response to the one or more images from the camera.

Clause 19. The dispenser of any preceding clause, wherein the processor is configured with a motion gated trigger to detect motion of the pet in response to the one or more images and activate a facial recognition routine in response to motion of the pet.

Clause 20. The dispenser of any preceding clause, wherein the motion gated trigger comprises a temporal momentum filter.

Clause 21. The dispenser of any preceding clause, wherein the processor comprises a low power configuration prior to the activation of the motion gated trigger and a high power configuration in response to the motion gated trigger, the high power configuration consuming at least about twice as much power as the low power configuration and optionally wherein the low power configuration uses an amount of power within a range from about 0.1 to 2 Watts and the high power configuration uses an amount of power within a range from about 2 Watts to about 10 Watts and optionally wherein the processor performs at least about twice as many floating point operations per second in the high power mode.

Clause 22. The dispenser of any preceding clause, further comprising a housing, and wherein the processor configured to identify the pet is contained within the housing.

Clause 23. The dispenser of any preceding clause, wherein the processor is configured with a trained neural network classifier, in which the classifier has been trained to identify the pet prior to a motion gated trigger being activated, wherein the motion gated trigger activates a facial recognition routine, and the processor is configured to open the food tray in response to the facial recognition routine identifying the pet.

Clause 24. The dispenser of any preceding clause, wherein a neural network classier is trained on a remote server in response to a user uploading a plurality of pet images from a user computing device to the remote server and wherein the trained neural network classifier is downloaded to the processor within the housing.

Clause 25. The dispenser of any preceding clause, wherein the processor is configured to dispense the wet pet food with an accuracy with 5 grams and optionally within about 3 grams and further optionally within about 1 gram.

Clause 26. The dispenser of any preceding clause, wherein the processor is configured to determine a cumulative amount of wet pet food dispensed from the wet pet food container.

Clause 27. The dispenser of any preceding clause, wherein the processor is configured, in response to the cumulative amount of wet pet food, remove the plunger from a backstay of the container and rotate a second container into position and dispense wet pet food from the second container.

Clause 28. The dispenser of any preceding clause, wherein the processor is configured to dispense a first portion of a meal from the container and dispense a second portion of the meal from the second container, in order to reduce residual food in the container.

Clause 29. The dispenser of any preceding clause, wherein the receptacle is configured to support the container when the plunger engages the container, the receptacle comprising an opening to pass dispensed food from an outlet on a distal end of the container with a clear path from the outlet to the food receptacle.

Clause 30. The dispenser of any preceding clause, further comprising a heating element to heat wet pet food dispensed into the food receptacle, wherein a distance from the heating element to a bottom of the food receptacle is less than a distance from the opening of the receptacle to the bottom of the container.

Clause 31. The dispenser of any preceding clause, wherein the opening comprises an aperture formed in the receptacle or a recess in the receptacle sized and shaped to pass the wet pet food through the opening while the receptacle supports the wet pet food container.

Clause 32. The dispenser of any preceding clause, wherein the plunger is configured to exert a force within a range from 20 to 60 pounds to dispense wet pet food from the container.

Clause 33. The dispenser of any preceding clause, wherein the plunger comprises a cylindrical rod with a distal end configured to engage a proximal end of the wet pet food container.

Clause 34. The dispenser of any preceding clause, wherein the container comprises a backstay, the backstay comprising a recess with a beveled edge to guide the wet pet food container and the plunger into alignment with each other.

Clause 35. The dispenser of any preceding clause, wherein the backstay comprises a gasket to seal against an inner wall of the wet pet food container and the backstay is configured to slide along the inner wall of the wet pet food container to dispense the wet pet food onto the food receptacle.

Clause 36. The dispenser of any preceding clause, further comprising a heating element to heat the wet pet food dispensed onto the food receptacle.

Clause 37. The dispenser of any preceding clause, wherein the heating element is located on the tray and moves with the tray when the tray is opened and closed.

Clause 38. The dispenser of any preceding clause, wherein the heating element is located below the food receptacle.

Clause 39. The dispenser of any preceding clause, wherein the heating element contacts the food receptacle when the food is dispensed from the container.

Clause 40. The dispenser of any preceding clause, wherein the processor is configured to, in sequence: read a code from a pet food container; dispense pet food from the food container into a feeding receptacle; heat the dispensed pet food in the feeding receptacle; and extend the tray.

Clause 41. The dispenser of any preceding clause, wherein in the processor is configured to provide an auditory stimulus to the pet to indicate that it is time to eat and optionally wherein the processor is configured to provide the stimulus after the food has been dispensed into the feeding receptacle.

Clause 42. The dispenser of any preceding clause, wherein the processor and the plunger are coupled to a linear actuator coupled to an encoder to measure an amount of displacement of the plunger.

Clause 43. The dispenser of any preceding clause, wherein the processor, the linear actuator and the motor are configured to dispense food with an accuracy within about 5 grams, optionally within about 3 grams and further optionally within about 1 gram.

Clause 44. The dispenser of any preceding clause, wherein the plunger is configured to dispense an amount of wet pet food from the wet pet food container within a range from about 0.3 grams to about 0.6 grams for each 0.1 mm of displacement when the container has been placed in the receptacle.

Clause 45. The dispenser of any preceding clause, wherein the outlet comprises a resiliently deformable, hydrophobic elastomeric material with one or more of a valve with slits or an orifice with a maximum dimension across of no more than about 10 mm and optionally no more than about 8 mm.

Clause 46. The dispenser of any preceding clause, wherein the outlet comprises a resiliently deformable elastic material with a Shore A hardness within a range from about 10 to about 70.

Clause 47. The dispenser of any preceding clause, wherein the outlet comprises a one way valve.

Clause 48. The dispenser of any preceding clause, wherein the plunger comprises a beveled, annular engagement structure to engage a beveled, annular engagement structure on the wet pet food container.

Clause 49. The dispenser of any preceding clause, wherein the engagement structures are configured to self center the container with the engagement structure.

Clause 50. The dispenser of any preceding clause, wherein the engagement structures are configured to mate with each other.

Clause 51. The dispenser of any preceding clause, wherein the engagement structures are configured to align an axis of the plunger with an axis of the wet pet food container when the plunger engages the wet pet food container.

Clause 52. A system for feeding a pet, the system comprising: the dispenser of any of the preceding claims; and a user computing system comprising a user interface, the user computing system configured to communicate with the pet food dispenser, the user interface configured to receive inputs from a user to control one or more of a frequency of feeding of the pet, an amount of food provided at each feeding of the pet, or a type of food provided at each feeding.

Clause 53. The system of any preceding clause, wherein the user computing system is configured to receive an amount of food consumed with each of a plurality of feedings of the pet.

Clause 54. The system of any preceding clause, wherein the user interface of the user computing system is configured for the user to select a type of wet pet food among a plurality of types of wet pet foods stored in the dispenser.

Clause 55. The system of any preceding clause, wherein the user interface is configured to receive a user input to adjust an amount of food dispensed at a feeding event and wherein the food dispenser is configured to dispense the food from the food container with an error of no more than two grams and optionally no more than one gram.

Clause 56. The system of any preceding clause, wherein the user interface is configured to display a number of unused food containers in the dispenser and a number of used food containers in the dispenser.

Clause 57. The system of any preceding clause, wherein, for each of a plurality of feeding events, the processor is operatively coupled to the load cell to measure an amount of food dispensed into the feeing container before the tray is extended and measure an amount of food remaining feeding container when the tray has been retracted and determine an amount of food consumed at said each of plurality of pet feeding events and wherein the user interface is configured to display an amount of food consumed at said each of the plurality of pet feeding events.

Clause 58. The system of any preceding clause, wherein the user computing system has been assigned a unique identification code, the dispenser has been assigned a unique identification code and each the plurality of pet food containers in the dispenser has been assigned a unique identification code and wherein the user computing system unique identification code, the dispenser unique identification code and said each of the plurality of pet food containers identification codes in the dispenser have been associated with each other to identify the unique identification codes of the plurality of containers in the dispenser as valid.

Clause 59. The system of any preceding clause, wherein the user interface is configured to receive a plurality of user inputs for a time and an amount of food for each of a plurality of pet feeding events.

Clause 60. A food cannister to dispense wet pet food, comprising: an outer housing comprising an annular shape; a circular backstay placed on a proximal end of the outer housing, the backstay comprising a recess sized to receive a plunger, a non-transitory machine readable code on an outer surface of the backstay, an inner surface of the backstay configured to engage wet pet food stored in the cannister; a gasket coupled to the circular backstay to engage an inner wall of the housing, wherein the gasket is located within a groove of the backstay; an outlet comprising one or more of an opening or a valve to release wet pet food from the cannister in response to the plunger engaging the backstay, the outlet comprising a hydrophobic material; and a base attached to the lower end of the distal end of the cannister, the base comprising an aperture to pass wet pet food released by the outlet.

Clause 61. The cannister of any preceding clause, further comprising a circular insert placed against the base and the outer housing, the circular insert comprising the outlet, the insert dimensioned to align the outlet with the aperture.

Clause 62. The cannister of any preceding clause, wherein the base comprises a cap.

Clause 63. The cannister of any preceding clause, wherein the outer housing comprises threads to engage threads to the base to firmly connect the base with the outer housing and optionally wherein the backstay is configured for a user to push the backstay out of the annular housing for cleaning.

Clause 64. The cannister of any preceding clause, wherein the machine readable code is located in the recess of the backstay.

Clause 65. The cannister of any preceding clause, further comprising a removable covering layer over the proximal end of the cannister and the machine readable code and wherein the machine readable code is exposed when the covering has been removed.

Clause 66. The cannister of any preceding clause, wherein the insert comprises an interior channel that defines an interior channel of a nozzle extending to the one or more of the opening or the valve.

Clause 67. The cannister of any preceding clause, wherein the outlet does not extend beyond the aperture.

Clause 68. The cannister of any preceding clause, wherein the backstay does not extend outwardly beyond a proximal end of the housing when the backstay and the machine readable code are covered with a covering layer.

Clause 69. The cannister of any preceding clause, further comprising a sealed layer of foil over the aperture on the base.

Clause 70. The cannister of any preceding clause, wherein the cannister in a sealed configuration comprises a proximal covering layer on the proximal end and a distal covering layer on the distal end.

Clause 71. The cannister of any preceding clause, wherein the one or more of the opening or the valve is defined with a hydrophobic silicone material.

Clause 72. The cannister of any preceding clause, wherein a maximum thickness of the insert, a dimeter of the annular housing, and a distance from the aperture to the backstay prior to engagement with the plunger are configured to deliver at least about 95% of the food present in the cannister prior to the plunger engaging the backstay.

Clause 73. The cannister of any preceding clause, wherein the annular housing, the backstay, and the base are rigid.

Clause 74. A non-transitory computer readable medium configured with instructions, that when executed by a processor, cause the processor to display a user interface on a user computing system, the user interface configured to receive user input for a plurality of pet feeding events from a pet food dispenser.

Clause 75. The dispenser, system, or method of any preceding clause, wherein the food receptacle comprises a metal receptacle to conduct heat to the dispensed food.

Clause 76. The dispenser, system, or method of any preceding clause, wherein the food receptacle comprises one or more of bowl, a pan or a tray.

Clause 77. The dispenser, system, or method of any of the preceding clauses, wherein the code on the pet food container comprises a unique identification code to identify the wet pet food container.

Clause 78. The dispenser, system, food cannister or method of any of the preceding clauses, wherein the code on the wet pet food container comprises one or more of a QR code, a bar code or an RFID code.

Clause 79. The dispenser, system, or method of any of the preceding clauses, wherein the wet pet food container comprises the cannister of any of the preceding claims.

Embodiments of the present disclosure have been shown and described as set forth herein and are provided by way of example only. One of ordinary skill in the art will recognize numerous adaptations, changes, variations and substitutions without departing from the scope of the present disclosure. Several alternatives and combinations of the embodiments disclosed herein may be utilized without departing from the scope of the present disclosure and the inventions disclosed herein. Therefore, the scope of the presently disclosed inventions shall be defined solely by the scope of the appended claims and the equivalents thereof.

What is claimed is:

1. An automated wet pet food dispenser to feed a pet, comprising:
a plurality of receptacles to receive a plurality of wet pet food containers;
a plunger to engage a wet pet food container among the plurality of wet pet food containers;
a camera to capture one or more images of the pet;
a processor operatively coupled to the camera, the code reader and the plunger, the processor configured with instructions to:
receive the one or more images;
identify the pet in response to the one or more images;
dispense wet pet food from the container among the plurality of containers onto a food receptacle with the plunger; and
extend a tray supporting the food receptacle to feed the pet in response to identification of the pet.

2. The dispenser of claim 1, further comprising a code reader operatively coupled to the processor to read a code on the wet pet food container.

3. The dispenser of claim 2, wherein the processor is configured to read the code on the wet pet food container before the plunger engages the wet pet food container.

4. The dispenser of claim 2, wherein the code reader is configured to read the code on a proximal portion of the wet pet food container.

5. The dispenser of claim 4, wherein the code reader is configured to read the code on a backstay of the wet pet food container.

6. The dispenser of claim 5, wherein the plunger is configured to at least partially cover the code on the backstay of the container and the code reader is configured to read the code on the container prior to the plunger engaging the backstay.

7. The dispenser of claim 2, wherein the code reader is configured to read the code on the pet food container prior to the pet food container being placed in a dispensing location.

8. The dispenser of claim 7, wherein the processor is configured to rotate the wet pet food container on a carousel to the dispensing location.

9. The dispenser of claim 7, wherein the plurality of pet food containers comprises a plurality of codes and wherein the processor is configured to read each of the plurality of codes prior to dispensing food from each of the plurality of containers.

10. The dispenser of claim 7, wherein the processor is configured to move a container at the dispensing location away from the dispensing location to read the code on the container and to move the container back to the dispensing location to dispense the food.

11. The dispenser of claim 2, wherein the processor is configured to compare the code on the container with a database of valid pet food container codes.

12. The dispenser of claim 2, wherein the processor is configured to identify the code as a valid code for use with the pet food dispenser.

13. The dispenser of claim 12, the processor is configured to is configured to dispense the wet pet food from the food container onto the feeing container in response to the valid code

14. The dispenser of claim 12, wherein the dispenser comprises a code to identify the dispenser and wherein the processor is configured to compare the dispenser code with the code on the food container to identify the code on the food container as a valid code.

15. The dispenser of claim 2, wherein the code reader comprises an illuminator to illuminate the code on the container.

16. The dispenser of claim 1, wherein the one or more images, wherein the one or more images comprises a plurality of images captured from the camera.

17. The dispenser of claim 1, wherein the processor is configured to identify the pet with a facial recognition routine in response to the one or more images from the camera.

18. The dispenser of claim 17, wherein the facial recognition routine comprises a convolutional neural network (CNN) classifier and wherein the classifier has been trained with a plurality of images from a camera of user computing device and the CNN classifier is configured to identify the pet in response to the one or more images from the camera.

19. The dispenser of claim 17, wherein the processor is configured with a motion gated trigger to detect motion of the pet in response to the one or more images and activate a facial recognition routine in response to motion of the pet.

20. The dispenser of claim 17, wherein the motion gated trigger comprises a temporal momentum filter.
